(19) United States
(12) Patent Application Publication
(10) Pub. No.: US 2026/0259773 A1
(43) Pub. Date: Sep. 3, 2026

(54) SYSTEM AND METHOD FOR AUTOMATED FREEDOM-CONSTRAINT CALIBRATION

(71) Applicant: Charles Reuben HOLLOWAY, Rolesville, NC (US)

(72) Inventor: Charles Reuben HOLLOWAY, Rolesville, NC (US)

(21) Appl. No.: 19/550,897

(22) Filed: Feb. 26, 2026

Related U.S. Application Data
(60) Provisional application No. 63/765,821, filed on Mar. 3, 2025.

(51) Int. Cl. G06F 9/50; G06F 11/30

(52) U.S. Cl. CPC G06F 9/5027; G06F 11/3058; G06F 11/3089; G06F 2209/508

(57) ABSTRACT

A system and method for optimizing resource use within a physical system, including: based on telemetry data, computing a freedom value for a physical system by subtracting a constraint value from a resource value—where the resource value describes an amount of a resource provided to the physical system, and where the constraint value describes a constraint which limits a use of the resource by the physical system; and adjusting the use of the resource by the physical system, by balancing the computed freedom value with respect to the subtracted constraint value, and altering a state of the physical system based on the balancing. Some embodiments may optimize resources use in computer processors such as graphical processing units (GPU) executing neural networks (NNs).

### RELATED APPLICATION DATA

The present application claims benefit from prior U.S. Provisional Application 63/765,821, filed on Mar. 3, 2025 and entitled “System and Method for Real-Time Constraint Optimization in AI, DeFi, and All Other Governance Systems”, which is incorporated by reference herein in its entirety.

### FIELD OF THE INVENTION

The present invention relates generally to control systems and, more particularly, to systems and methods for automatic, intelligent calibration of technological systems.

### BACKGROUND OF THE INVENTION

Various physical systems—such as, e.g., mechanical and/or electrical or computing systems—tend to gradually lose efficiency over time. This loss, also referred to as drift, often results from the accumulation of small imbalances as systems operate. Left uncorrected, drift drives every system toward failure—which may result from, e.g., stagnation or chaos.

Various engineering solutions have traditionally tried to slow drift by setting manual limits and thresholds—as well as corresponding adjustments aimed at keeping systems stable and minimizing drift. These reactive methods rely on reading system output, then modifying the system's state, meaning the system has already drifted before correction begins. Each adjustment thus compensates for past deviation rather than preventing future drift, so the resulting stability may be temporary and inefficient.

Thus, there is a need of replacing manual, reactive tuning methods with a real-time, autonomous calibration processes responding to live system data and allowing for continuous optimization and improved drift management.

### SUMMARY

Some embodiments may provide a system and method for optimizing resource use within a physical system, such as a computing or electrical system, allowing for avoiding drift and preventing system inefficiencies through continuous calibration.

Based on telemetry data, some embodiments may compute a freedom value for a physical system by subtracting a constraint value from a resource value—where the resource value describes an amount of a resource provided to the physical system (e.g., power in watts), and where the constraint value describes a constraint which limits a use of the resource by the physical system (e.g., the effect of a processor's temperature on how much the power supplied to the it may be converted into compute operations). Some embodiments may adjust the use of the resource by the physical system (e.g., adjust the utilization of power by the system), by balancing the computed freedom value with respect to the subtracted constraint value, and altering a state of the physical system based on the balancing (e.g., apply constraints to the system to alter its state by increasing or decreasing its temperature—which may be associated with a higher/lower constraint value that may then be subtracted from the resource value, and consequently, with a new F or freedom value). A freedom (e.g. F) value may represent a system's freedom to amplify or attenuate the magnitude of a constraint being applied.

Some example embodiments may optimize resource use in computer processors such as graphical processing units (GPU) executing neural networks (NNs). Different embodiments may be used for intelligent calibration processes on different physical systems.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the invention;

FIG. 2 shows an example sub-equation mapping process according to some embodiments of the invention;

FIG. 3 illustrates an example automatic calibration system including a scheduler according to some embodiments of the invention;

FIG. 4 illustrates an example scheduler unit according to some embodiments of the invention;

FIG. 5 illustrates an example operation workflow of a Rule-Trigger-Constraint (RTC) module according to some embodiments of the invention;

FIG. 6 illustrates an example automatic calibration system including tau and lambda loops according to some embodiments of the invention;

FIG. 7 shows an example automatic calibration system including a supervisory loop according to some embodiments of the invention;

FIG. 8 shows an example automatic calibration system coupled to a graphical processing unit (GPU) according to some embodiments of the invention; and

FIG. 9 illustrates an example process for optimizing resource use within a physical system according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Some embodiments may be used for resource use calibration or optimization within physical systems (such as, e.g., electrical devices, including computer processors and software systems, including machine learning systems—as well as additional or alternative systems and devices, simply referred to as “system” herein).

Based on telemetry data (e.g., temperature and/or voltage sensor readings, and the like), some embodiments may compute or derive the system's freedom—for example representing a portion of a resource available to the system under real-time conditions, where constraints limit the use of the resource (such as, e.g., the amount of electric power provided to a computer processor that is available to perform computations, after a portion of electric power is lost due to constraints or inefficiencies resulting from temperature and voltage factors). Some embodiments may then adjust the use of the resource by the system or device, for example by adjusting constraints with respect to computed freedom values (for example, by modifying power limits, clock frequencies, voltage margins, or altering a state of the system using other operational parameters in response to changes in freedom; this may also be referred to as freedom-constraint balancing, or as balancing freedom and constraint).

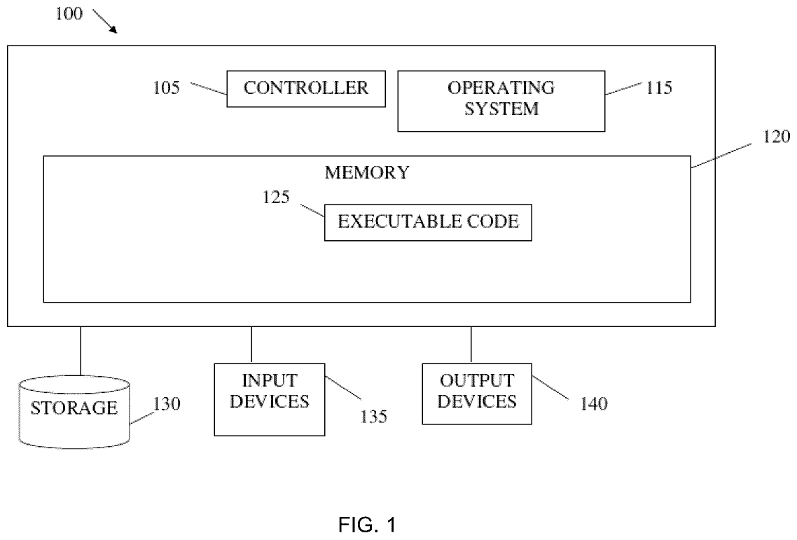

FIG. 1 shows a high-level block diagram of an exemplary computing device which may be used with embodiments of the invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

As used herein, efficiency may refer to a system's capacity to sustain its intended output using a given level of resources without requiring increasing control, correction, or regulation over time. A loss of efficiency may occur, e.g., when accumulating imbalances force the system to expend more energy, coordination, or constraint to maintain the same level of function. For example, a computer processor (e.g. operating a cloud system, a server, a desktop, machine learning, etc.) operating at 3.0 giga-Hertz (GHz) may initially sustain 300 Giga Floating-Point Operations Per Second (GFLOPS) at 80 Watt (W) while maintaining a junction temperature of 70 degrees Celsius (° C.). As heat accumulates over time (which may be considered as or reflected in constraints applied to the system), the same processor may require 95 W (which may be considered as an example resource provided to the system) to sustain only 270 GFLOPS due to thermal leakage and throttling, or may require additional cooling or tighter thermal controls (namely, additional constraints) in order to remain at 3.0 GHz. In this nonlimiting example, useful compute per unit of energy or energy transfer decreases as a constraint is applied (as a temperature increase), and additional regulation or constraints are required to maintain stability, indicating a loss of efficiency even though the processor remains operational.

Various systems—mechanical, electrical, thermodynamic, and informational—tend to gradually lose efficiency over time. This loss, also referred to as drift, may result from the accumulation of small imbalances as systems operate. Left uncorrected, systems may drift toward one of two extremes. The first extreme may be referred to as over-constraint, which may lead to stagnation—rules and controls may become so rigid that the system loses adaptability. The other extreme may be chaos or instability—constraints may weaken until control is lost entirely. In either case, drift may cause the system to fail.

Referring back to the nonlimiting use case example of a computer processor—over-constraint may occur, e.g., when thermal controls become overly rigid and various constraints are applied, such as, e.g., forcing the clock from 3.0 GHz to 1.8 GHz once temperature exceeds 70° C., reducing throughput from 300 GFLOPS to 170 GFLOPS while power drops from 80 W to 55 W, leaving available cooling and performance headroom unused. The opposite extreme, chaos or instability, may occur when constraints are too weak or when fewer constraints are applied, such as, e.g., allowing the processor to continue operating at 3.0 GHz and 90 W as temperature rises beyond 70° C.—which may trigger rapid throttling oscillations, and result in failures such as, e.g., computation errors or emergency shutdowns. Efficient operation may lie between these extremes, where clock, voltage, and thermal limits adjust smoothly to sustain near-peak compute while maintaining stable temperature and power margins.

Engineers have traditionally tried to slow drift by setting manual limits and thresholds—representing static, guesswork/heuristic adjustments meant to keep systems stable. These reactive (rather than anticipatory or proactive) methods rely on reading system output, meaning that the system has already drifted/errored before correction begins. Each adjustment may compensate for past deviation rather than preventing future drift, so the resulting stability is often temporary and inefficient.

For example, a processor may be configured with a fixed thermal throttle point of 85° C., at which (upon measuring a temperature exceeding this threshold) a constraint may be applied to the system: e.g., a clock frequency may abruptly be reduced from 3.0 GHz to 2.0 GHz. However, by the time this threshold is reached, power consumption may have already risen from 80 W to 95 W and temperature may be increasing at several degrees per second, meaning the system has already drifted outside its optimal operating range. The subsequent throttling corrects past overheating rather than preventing it, resulting in oscillations between 2.0 GHz and 3.0 GHz, average throughput reduced to 230 GFLOPS, and unnecessary energy loss.

To prevent or mitigate drift and improve energy utilization, some embodiments may use a Freedom-Constraint (also denoted F-C) Equation in an automatic and continuous calibration process—which may replace manual, reactive tuning with real-time, proactive and autonomous calibration and resource use optimization. Some embodiments may dynamically and/or continuously adjust system constraints (and, consequently, the use of the resource by the system) in response to live system data, maintaining balance between the corresponding system-freedom and system-constraint values so that continuous optimization is achieved.

As used herein, “continuous calibration” may refer to may refer to a real-time, iterative calibration process where live telemetry data is used to proactively and continuously-change or maintain a state of a physical system without depending on fixed trigger points or thresholds (the latter possibly being used for reactive calibration, taking place after the system has already drifted into a state triggering a predefined condition or threshold). Continuous may mean iteratively and repeatedly, in a constant or continual manner.

In this context, a system's state may be defined as a set of thermodynamic state variables and/or machine-readable operational parameters that collectively characterize the current configuration or operating condition of a system at a given point in time. For instance, a processor's or GPU's state may refer to any machine-readable operating parameter of the device that can be adjusted to change its consumption or use of a resource such as for example electric power provided to the processor. A nonlimiting example of such a state may be the GPU's clock speed or frequency (see some nonlimiting use case examples herein) which governs the electrical power drawn by the GPU during computation. Reducing a GPU's clock frequency from X to Y, or reducing a variable-speed fan's drive level from A% to B%, are examples of altering system states, which may modify the use of a resource—e.g., the electric-power usage profile—of the corresponding physical and electrical device. Additional or alternative example states and resources may be considered in different embodiments.

A nonlimiting use case example highlighting differences between existing control systems and a continuous calibration process according to some embodiments of the invention is provided in Table 1:

In this nonlimiting example, a variable-speed fan may be or may constitute a part of a physical system (which may also include, e.g., additional components such as a computer processing unit or graphical processing unit being cooled by the fan), and may include an airflow-generation assembly and a control subsystem as an electrical device in which, for example, the rotational speed of a brushless direct-current motor may be modulated by electronically varying the applied drive voltage or pulse-width-modulated duty cycle.

### Variable-Speed Fan—Traditional Control

System: Cooling fan controlling temperature
Goal: Maintain approximately 80° C.
Actuator (a physical device that converts an electronic control signal into a corresponding mechanical action or adjustment within a system, allowing to alter the system's state): Three-speed fan (States: Low/Medium/High)

Control rule (fixed thresholds):
If temperature is below 80° C.→Fan=Low
If temperature is between 80° C. and 85° C.→Fan=Medium
If temperature is above 85° C.→Fan=High

Example:
At 84° C.→Fan=Medium
At 85.1° C.→Fan switches to High

The fan may not change gradually. It may switch between preset levels when temperature crosses fixed thresholds.

### Variable-Speed Fan—Freedom-Constraint Based Continuous Control

Define:

Resource value R=the amount of electrical power being provided or supplied to the system and/or fan motor.

The maximum allowed power may be defined or represented as 100 R-units.

(This scale may be defined or established, for example, manually, by the system's designer.)

In this example, 100 defines the upper bound of the internal control (0-100) scale used to regulate variable fan speed.

Based on telemetry data such as, e.g., temperature readings where:

The current temperature (or thermal state of the system or electrical device) is measured as 84° C., and given a temperature reference point: 80° C.

A mapping function (which may, for example, C(T)=10·(T−80° C.) and may be defined and/or provided by the system's designer) maps the measured temperature (84° C.) to an R-unit value of, e.g., 40.

That value becomes C in the FC equation: it may represent a constraint which limits the use of the resource provided to the system—such as for example the effect of the system's temperature on the power available to perform work (also referred to as the “unconstrained” resource).

So: C=10·(84° C.−80° C.)=40.

Some embodiments may compute a freedom value for the system by subtracting constraint value C (computed based on temperature telemetry data) from resource value R:
F=(R−C)/R
F=(100−40)/100
F=0.60

F=0.60 indicates that, under current measured conditions, 60% of resource R is presently unconstrained, or is available to perform work (and its use by the system is not limited by system degradation or drift due to temperature effects).

A real-time constraint module (also referred to herein as RTC) receives F=0.60 as the current state indicator. The RTC may use the current value of F and engineer-defined rules to generate a control instruction. That instruction may sent to the voltage regulator controlling the fan motor, to alter the state of the system (e.g., to change the fan's drive or speed) to balance freedom and constraint (see discussion herein)—and adjust the use of the resource by the system (e.g., to change the use of power by the fan). For example: when the measured temperature is 84° C., the RTC may issue a command to increase fan drive (e.g., by altering voltage as demonstrated below). In the next cycle, if the measured temperature changes to 83.7° C., the system may compute new C and F values for that cycle (corresponding to the newly measured temperature), and the RTC may issue a slightly reduced drive command. In the next cycle again, if the temperature drops to 83.2° C., the RTC may issue a further reduced drive command. The exact voltage level for each possible temperature reading may be determined, e.g., by the engineer-defined rule inside the RTC.

As a non-limiting example, the engineer-defined rule may specify a continuous quantitative mapping from the computed F value to a corresponding fan-drive voltage value V such that V(F)=V_min+(V_max−V_min)·F, where V_min=5.0 V and V_max=12.0 V. Under this rule, when the computed F value is F=0.60, the RTC may compute V(0.60)=5.0 V+7.0 V·0.60=9.2 V and issue a digital command or control word (which may be, e.g., an 8-bit or 16-bit register value that encodes the desired output level) specifying “9.2 V” to the voltage regulator. The command or control word may be sent or transmitted over a communication or data network, transferred over a wired connection, and the like, to change or alter the state of the system (as manifested in state variable such as, e.g., voltage and/or temperature). If in the next cycle the updated system state yields F=0.57, the RTC may compute V(0.57)=5.0 V+7.0 V·0.57=8.99 V and send a slightly reduced control word; if the next cycle yields F=0.51, the RTC may compute V(0.51)=5.0 V+7.0 V·0.51 =8.57 V and send a further reduced control word.

According to some embodiments, a voltage regulator (which may be, e.g., an electronic circuit including internal power-switching elements such as, e.g., metal-oxide-semiconductor field-effect transistors (MOSFETs)) may receive this control word over, for example, an inter-integrated circuit, a wired bus (such as, e.g., the system management bus or SMBus), or a different communication interface, and may convert it into a corresponding pulse-width-modulated (PWM) gate-drive signal for its power MOSFETs, such that the PWM duty cycle changes (e.g., from 60% at 84° C. down to 58.5% at 83.7° C. and 56.5% at 83.2°C.), and the average DC voltage actually applied across the fan motor windings changes “mechanically” from approximately 7.2 V to 7.11 V to 6.96 V, respectively; this gradual change in electrical drive torque may cause a proportionally smooth change in fan rotational speed (e.g., from 2,800 rpm to 2,750 rpm to 2,680 rpm). As shown in the above example, since the mapping into R units and the range of possible of F values are continuous, the resulting adjustments to voltage (and consequently to the use of electric power by the system) may also be continuous: a change in voltage may be introduced for every value of F, without having to specify specific F values for which the voltage changes, or define hard coded thresholds or conditions as required in previous control systems.

As the state of the system changes and the measured temperature changes gradually from cycle to cycle, the computed F value may change gradually, and the RTC's output command may also change gradually. The voltage regulator may alter the system's state accordingly—e.g., adjust the fan speed, and the corresponding use of electric power provided to the system. The change may thus be continuous, not step-based. The cycle may be repeated iteratively and/or continuously.

### Table 1

Additional or alternative use case examples (including, e.g., additional or alternative regulation components which may receive control words or commands from RTC components) and/or operations may be used in different embodiments.

As used herein, “telemetry data” may refer to measurements of operational state variables of a system (such as, e.g., an electrical device). Telemetry may include, e.g., time-resolved values of temperature (° C.), voltage (V), current (A), power (W), clock frequency (Hz), and the like—which may be used to perform calibration processes according to some embodiments of the invention (e.g., as part of calculating and balancing resource, constraint, and freedom values). In some embodiments, telemetry data may be acquired from on-die sensors, voltage regulator modules, or performance counters coupled to or in communication with the relevant system or device, and sampled at defined intervals to characterize real-time operating conditions. Different telemetry sources or sampling resolutions may be used in different embodiments.

Through a Freedom-Constraint Equation and its related forms—τ, Λ, and P (see example Eqs. 2-4 herein)—some embodiments may provide a unified framework for autonomous calibration. Some embodiments may eliminate drift, maintain dynamic stability, and drive systems toward their operational maximums—the highest sustainable efficiency each system may achieve in practice.

Some terms used in the present document are explained or described in Table 2:
Constraint: An operational change in how much a rule or a change in the state of a system subtracts from usable potential (denoted R).
Calibration Loop (Local): A calibration or computation cycle governed by a single Sub-Equation and its paired RTC (both may be, e.g., dedicated software modules or components executed by a processor, e.g., of a scheduler component used for executing F-C processes according to some embodiments). It measures the state of its domain, converts that reading into R-units, applies a constraint, and updates the system's usable potential (R). Each local loop—A, B, C, and so on—maintains balance within its own domain.
Calibration Loop (Global): The larger system cycle or loop coordinated by the Scheduler (which may include a plurality of calibration iterations). It sequences all Sub-Equations in turn, collecting their outputs and updating the Freedom-Constraint Equation once per full pass. The global loop defines the system's overall calibration rhythm and ensures stability among local loops.
Domain: A domain is the set of system components or variables that share a direct causal relationship through the same energy path or control mechanism. If a sensor/sub-equation measures heat, its domain is everything that changes temperature—voltage, current, cooling flow, thermal resistance, etc.
Drift: A thermodynamic deviation from a system's optimal efficiency. Drift occurs gradually as small imbalances accumulate during operation, causing the system to move away from equilibrium. It is not a sudden failure but a continuous loss of efficiency over time, appearing as excess heat, wasted energy, delayed response, or informational noise. Using Freedom-Constraint processes according to some embodiments of the invention, drift may be prevented rather than corrected—the system maintains internal balance so deviation never accumulates.
Ideal Freedom: The theoretical condition that exists when all resources in a system are fully available for use toward a goal or for performing an operation function, without loss, friction, or interference.
Limit: A fixed boundary beyond which something cannot go (applies, e.g., to quantity, speed, time, etc.).
Operational Freedom: Operational freedom represents the amount of usable resources remaining in a system after the effects of a constraint are considered. As a constraint increases (as may be reflected in a constraint value C in the F-C equation-see Eq. 1), the system's freedom to convert resources into system-output decreases; as a constraint decreases, this freedom increases. The equation formalizes this balance, describing how freedom varies as a direct function of a constraint upon the system's ability to use resources to achieve a goal or perform a function.
R-Units (Resource Units): A standardized measure of usable potential within a system. Each Sub-Equation may convert telemetry data or raw sensor data—such as heat, power, or data flow—into R-units so that all forms of activity can be compared and controlled on a common scale. R-units express how much of a system's total potential (R) currently has the Freedom to do Work, allowing mechanical, electrical, and informational processes to be calibrated using a single reference unit.
Resource: A source of operational capacity available for use towards a goal or to perform an operational function, and can be predictably controlled. It may be represented as a resource value R in the F-C equation (Eq. 1).
Rule: A fixed, externally imposed specification that defines:
Which part of a system's usable potential (R) is subject to subtractive control,
How much potential to subtract under specific conditions, and
The trigger condition for when that subtraction occurs.
Static Constraint or a fixed-value constraint: a rule or limit set to a single, pre-determined value that does not vary with system feedback. It may be expressed as a single number, range, or lookup table, but remains unchanged, e.g., until manually reset.
Structure: A set of elements standing in interrelationships.
Sub-Equation: A Sub-Equation may measure any proper subset of a system, including the system as a whole. It may convert live telemetry/sensor data from that subset into R-units, representing usable potential within that domain. Each Sub-Equation may operate independently and may feed its results to the Freedom-Constraint process for calibration. As used herein, a “Sub-Equation” may refer to a software module or component that processes sensor or telemetry data and outputs derived quantities and/or information to a F-C process of which it is a part. In some embodiments, Sub-Equations may comprise computerized data-processing operations that may be orchestrated, for example, by a scheduler component, and that may not limited to purely mathematical calculations. Various embodiments of the invention, however, may not rely on a sub-equation based architecture: in some embodiments, measured sensor data or thermodynamic quantities may be mapped into R-units, and the R-unit value may be used to periodically update C in an F-C equation. Some nonlimiting operations described with regard to some example embodiments as carried out by a sub-equation module may otherwise be carried out by additional or alternative modules or components, e.g., within a scheduler component and without referring to sub-equations (see, e.g., nonlimiting use case example provided in Table 1, which does not rely on a sub-equation based architecture).
System: A structure activated by the flow of energy. An energized structure that regulates the use of a resource, balancing freedom and constraints, to produce a predictable outcome. Such a system may include a physical system, a mechanical system, a computing system, a software system (embodied or executed by physical processors), or other systems.
Theoretical Maximum: A mathematical ceiling that represents the highest possible efficiency or output of a system under idealized, frictionless, closed-system conditions. It assumes no losses, perfect conversion of energy, and no constraints. Theoretical maximums are useful reference points, but they describe abstraction rather than operational reality.
Operational Maximum: The highest sustainable efficiency or output that a real system can achieve under its actual governing principles and constraints. Unlike a theoretical maximum, the operational maximum accounts for drift, resistance, and other unavoidable losses. It defines the point at which a system remains stable while converting the greatest usable potential (R) into work in practice—and may be identified only through continuous calibration such as, e.g., described herein.

### Table 2

Instead of relying on human operators to apply static, arbitrary constraints—or waiting for an error to appear in the system's output—some embodiments may use the Freedom-Constraint Equation to make continuous adjustments to the system's state in real time—and specifically, without having to rely on static, hard-coded thresholds for sensor measurements that, when exceeded—the system has already drifted into a state where resource utilization is suboptimal (as done in previous or existing control systems). Some embodiments may dynamically balance constraint and freedom values, preventing the system from drifting into chaos or stagnation—by quantifying constraint drift and correcting it automatically.

Some embodiments of the invention may compute a freedom value for a physical system, wherein the computing is performed by subtracting a constraint value from a resource value, wherein the resource value describes or represents an amount of a resource provided to the physical system, and wherein the constraint value describes or represents a constraint which limits a use of the resource by the physical system.

An example Freedom-Constraint equation according to some embodiments of the invention may be, e.g.:
(Eq. 1) F(C)=(R−C)/R; where 0<C<R

This example equation defines the relationship between Freedom (F), Constraint (C), and Resources (R) values for a physical system or device. Other or additional operations and parameters may be included; for example a Freedom-Constraint equation may be based on Eq. 1. Resource value R may represent an amount of a resource (e.g., a total of X watts provided to the system), or entities with operational existence, provided to the system that can be predictably directed toward a goal. Constraint may refer to an operational change limiting the use of the resource R and representing, e.g., how much a rule subtracts from usable potential or amount R, triggered by live system feedback (e.g., how much a change in the physical system's temperature subtracts or adds to the power available to perform compute operations). Freedom (F) may thus be defined operationally by the equation—which may be used to compute an F value by subtracting a C value from an R value.

Some example embodiments may be used to optimize resource use in a physical system which include an electrical device, telemetry data may include data measured by one or more sensors in communication with the electrical device, and the resource may include electrical power provided to the electrical device. In some embodiments, sensor readings may comprise one or more of: a temperature reading, a voltage reading, and a clock reading; the use of the resource may describe available computing power, and the constraint may describe, e.g.: a thermal state of the electrical device, an electrical state of the electrical device and the effect of the one or more of: the thermal state of the electrical device, and the electrical state of the electrical device on the available computing power.

For instance, referring back to the nonlimiting use case example of a computer processor (which may be, e.g., a graphical processing unit (GPU); although other use cases and different electric devices may be considered in different embodiments, such as CPUs or non-computing systems): an R value or resource value may represent the total electrical power as, e.g., supplied by the voltage regulators, e.g., the energy that could in theory be converted into computation. If the GPU draws 100 W, this may be considered as the total resource available for processing by the system. A C value may be subtracted from R to compute F, and may represent a limited portion of R, or a use of resource R needed to maintain efficiency when limited by a constraint C—such as, e.g., accounting for thermal limits, voltage margins, and timing considerations. For example, at a junction temperature of 70° C. and 0.95 Volt (V) measured by the relevant sensors communicating with the GPU or device, the GPU may require a small constraint, say C=10 W (representing, e.g., a portion of the resource used for cooling the system), limiting the use or R and leaving F=R−C=90 W as the computing power usable or available for computation. The computed, operational freedom F corresponds to the actual throughput achievable—e.g., 300 GFLOPS. As temperature rises to 85° C. and voltage changes to 1.05 V, thermal leakage and stability concerns require a larger constraint (or, e.g., using more power for colling), C=30 W, reducing operational freedom to F=70 W and lowering sustained throughput to 250 GFLOPS, even if the nominal clock remains 3.0 GHz. Thus, F is continuously determined by real-time conditions, representing the portion of the supplied resource R that is truly usable for computation after constraints (such as, e.g., temperature) are applied, while ideal freedom—100% conversion of R to compute—remains unattainable due to physical limits.

In this example, it is shown that C may describe the effect of a system's or device's state or states—and of the altering its state-on resource utilization. The system's state may be defined or may be determined by one or more state variables, including, e.g., temperature, voltage and the like. In the above example, C describes the effect of altering the GPU's state—as reflected, e.g., in temperature (or its thermal state: initially 70° C., then 85° C.) and voltage (or the GPU's electrical state, e.g., voltage within the system, initially 0.95 V, then 1.05 V)—on the available computing power (reflected, e.g., in power usable for computation and eventually, e.g., in GFLOPS), or on the use of the resource (namely, the use of power for computation) as determined by real time conditions. For instance, a GPU's state, such as for example its clock speed (representing the number of computations or instructions performed per unit time), may be altered from X to Y to adjust or control the use of a resource, e.g., the electric power provided to the GPU—and the amount of power utilized by the GPU to perform computation (as opposed to amounts of power that dissipate, for example, as resistive and capacitive switching losses within the GPU's circuits). In this manner, a reduction in clock frequency may reduce the instantaneous electrical load and thermal output of the device (which may reduce the GPU's temperature), thereby improving overall energy utilization by shifting a larger fraction of the supplied electrical power toward useful computational work rather than heat dissipation. Additional or alternative system states may be altered in different embodiments.

In the above example, telemetry data or sensor readings such as, e.g., a temperature reading, a voltage reading, and a clock reading for a GPU may be obtained, for example, via integrated on-die sensors and supporting monitoring circuits. A junction temperature may be measured, e.g., by thermal diodes or ring oscillators embedded in the GPU die, with signals routed to the GPU's thermal monitoring unit (TMU) and read through internal registers accessible via a Peripheral Component Interconnect Express (PCIe) or different system management interface. Voltage may be measured, e.g., using on-chip sense resistors or analog-to-digital converters (ADCs) connected to the GPU's power delivery network, often supplied by dedicated voltage regulator modules (VRMs), which may communicate real-time voltage levels to the GPU controller. Clock frequency may be tracked, e.g., via phase-locked loops (PLLs) or internal counters or readers within the GPU, which may provide cycle-accurate timing readings to performance counters. These sensor values may be continuously polled by the GPU driver or firmware, providing real-time inputs used in the F-C scheduling process to calculate constraints C and operational freedom F, accounting for thermal, voltage, and timing limits.

Some embodiments may provide automatic calibration systems and methods providing technological improvements such as, e.g. improving CPU or GPU performance-per-watt; increasing communication efficiency across nodes in blockchain systems such as, e.g., the Ethereum system; achieving performance gains in machine learning tasks such as, e.g., inference and/or orchestration; and delivering performance gains in combustion engine calibration. Additional or alternative use case examples and technological improvements may be provided by different embodiments.

An example automatic calibration process may include example operations such as: real-time operational data or telemetry data may be read by multiple sensors and may be input into sub-equations, each sub-equation reporting on an attribute, a state variable, or a thermodynamic aspect of the system—such as for example temperature, data transfer rate, or power flow. This data may then be fed into an F-C equation, which may adjust the corresponding constraint and the use of resources by the system to maintain equilibrium.

In some embodiments of the invention, mapping functions may be employed to convert raw sensor signals or measured telemetry data into usable units or into an internal control scale—such as converting a voltage to temperature, or a throttle position to fuel rate and/or to different internal control scale units—so the signal may be used locally in control logic or lookup tables. Each function may serve a single feedback loop or subsystem, although different functions may be used in different embodiments.

A Freedom-Constraint based automatic calibration process according to some embodiments may require and/or use every sub-equation to perform this mapping consistently, so that the constraint variable or value C is always expressed in the same unit system as R, where R is defined as the total resource amount that may be used or converted into the system's output.

Unlike previous control systems and methods which treat each feedback channel in its own native units, some embodiments may define R-units in terms of a system's primary operational units. By doing this, an F-C calibration process according to some embodiments may establish a common quantitative language that can be applied to optimize/calibrate internal processes of various technological systems.

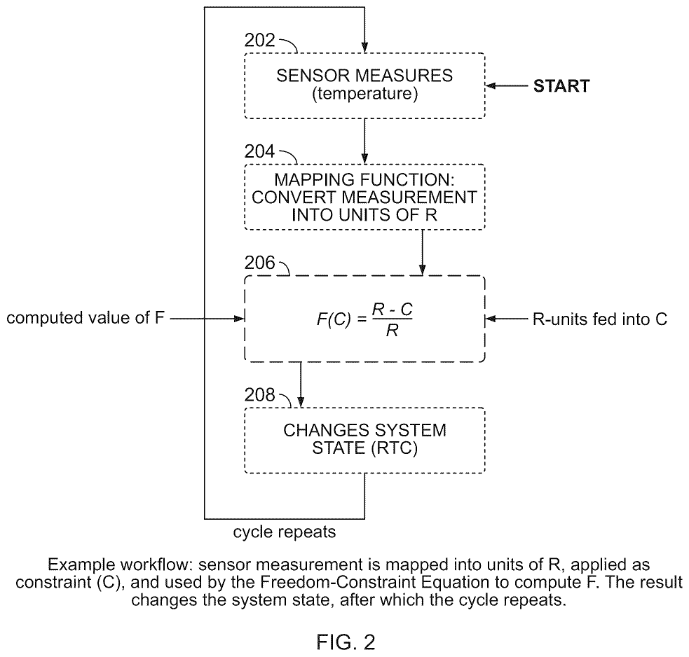

FIG. 2 shows an example sub-equation mapping process according to some embodiments of the invention.

According to some embodiments, a raw signal (such as, e.g., a temperature reading) may be measured (operation 202) and mapped into an internal control scale or to units of R (operation 204), then fed into the Freedom-Constraint Equation (e.g., Eq. 1) as a constraint value (C; operation 206). The equation may then be used to compute (e.g., using the F-C equation, or Eq. 1) how much of resource R remains usable. For instance, in the nonlimiting use case example of a GPU, a temperature reading may be expressed as a constraint value C in compute-per-watt (e.g., GFLOPS per W), which may be subtracted from a resource value R expressed in the same units and corresponding to the theoretical utilization of all power into compute, or the maximal compute-per-watt given an input power of X watts. The result of the subtraction of the constraint value from the resource value—namely, the computed freedom value (see Eq. 1)—may be used to change the system's operational state (e.g., using rule-trigger-constraint mechanisms; operation 208). Subsequently, the cycle may repeat itself (e.g., periodically, an iteration every t seconds). In each iteration, the updated, newly determined constraint value C may be subtracted from resource value R and result in a newly computed value of F. That change, in turn, may provide the input that activates a Rule-Trigger-Constraint (RTC) mechanism to alter the operational state of the system. Additional or alternative operations may be performed by different embodiments.

Various complex technological systems may operate under many conditions at once, meaning that multiple sub-equations may be used to continuously feed data into the computation of C. According to some embodiments, each sub-equation may be used to represent a different constraint factor or limiting factor—such as, e.g., temperature, bandwidth, voltage, latency, load, and so on.

Some embodiments may map data measured by one or more sensors into an internal control scale, and the freedom value may be computed using the mapped data. In some embodiments, telemetry data may include one or more of: a memory bandwidth usage within the GPU, and a network latency across one or more computing nodes.

For instance, an AI inference workload (executed, e.g., by a system or device such as a GPU) may be described using multiple sub-equations, each measuring a different limiting factor based on different telemetry data. For example: an example F-C process according to some embodiments may use sub-equation 1 to measure GPU temperature; sub-equation 2 to measure memory bandwidth usage; and sub-equation 3 to measure network latency across compute nodes. The process may map the raw temperature data into an internal control scale and/or into the units of R, e.g., by transforming measurements into values expressed in the same units as R (such as for example performance-per-watt for GPUs). It may all feed data into C, and some embodiments may prioritize and balance these inputs. Some nonlimiting example sensor data to internal control scale mapping processes according to some embodiments of the invention are provided in Table 3:

A nonlimiting example F-C process may begin by measuring thermodynamic properties of the system. Appropriate sensors may report physical conditions such as temperature (° C.), voltage (V), current—or in the nonlimiting example of an Ethereum blockchain system, message rate (messages/sec), or network latency (in milliseconds). Clock speed, while not being a thermodynamic property, may be an actuator-controlled variable that influences the system's thermodynamic state.

Thermodynamic sensor data may be mapped or converted, using an engineer-defined mapping function, into R-unit value based on a predefined an internal control scale or R-unit scale (see also, e.g., nonlimiting example in Table 1). The size of the internal control scale (e.g., 0-100 or 0-1000) may be system-specific: different ranges of values may be used in different embodiments.

The examples below illustrate how different measured quantities can be mapped into R-unit scales.

### Example 1—GPU Temperature Mapping

This example illustrates how a measured GPU temperature value (or thermal state of the GPU) may be converted into an internal R-unit value using a defined R-unit scale. The measured temperature (in ° C.) may be mapped linearly into a 0-100 R-unit scale. The resulting R-unit value represents the system's current state on that internal scale and may then be used to update C in the F-C equation.
Temperature range: 0-120° C.
R-unit scale: 0-100 R-units
Linear conversion:
R-unit value=(Temperature/120)×100
Measured temperature=84° C.
R-unit value=(84/120)×100
R-unit value=70
So:
84° C.→70 R-units

Thus, temperature data mapped into internal control units, or mapped data, may be used to compute a freedom value (and, e.g., by substituted for the C value in Eq. 1).

### Example 2—Ethereum Message Rate Mapping

This example illustrates how a measured Ethereum message rate is converted into an internal R-unit value using a defined R-unit scale. The measured message rate (in messages per second) may be mapped linearly into a 0-1000 R-unit scale. The resulting R-unit value may represent the system's current state on that internal control scale and may then be used to update C in the F-C equation.
Message rate range: 0-15,000 messages/sec
R-unit scale: 0-1000 R-units
Linear conversion:
R-unit value=(Message Rate/15,000)×1000
Measured message rate=12,000 messages/sec
R-unit value=(12,000/15,000)×1000
R-unit value=800
So:
12,000 messages/sec→800 R-units

Ethereum network latency (measured, e.g., in milliseconds), or network latency across one or more Ethereum nodes may be mapped into R-units using the same approach, by defining a latency-to-R-unit mapping function.

According to certain embodiments, mapped values may be substituted for the C variable in the F-C equation (e.g., Eq. 1) to calculate an F value, which may be used or read by an RTC module or component to alter or change the state of the system (see also nonlimiting example in Table 1).

### Table 3

Additional or alternative mapping operations may be used in different embodiments.

To continuously apply multiple constraints in real time based on live system data, some embodiments may perform control processes including: 1. Time Control—which may determine when data is processed and regulates the order of adjustments. 2. Weight Control—which may determine the relative impact of individual constraints or limiting factors, dynamically amplifying or attenuating them based on real-time inputs.

When multiple sub-equations are used, their inputs may be sequenced in time to avoid interfering with each other. Time Control may refer to a mechanism that regulates this order.

In a nonlimiting use case example of machine learning or AI model inference (executed, e.g., by a GPU), workload may be distributed across multiple compute nodes. Suppose three sub-equations are used in an F-C process to monitor three separate conditions that may affect processing performance (as reflected, e.g., in computational times), such as for example: 1. GPU utilization (load); 2. Rate of data transfer between a GPU's own VRAM and its compute cores (memory bandwidth); and 3. Network latency across GPUs (nodes). Each sub-equation may be used to continuously measure a specific aspect of the system, and the process may convert it into R-units and share it with a processing unit or scheduler. In some embodiments, the processor or scheduler may retrieve and apply sub-equation outputs and place them in a sequence at scheduled intervals. Some embodiments may read raw sensor data in a serial manner to prevent conflict between measurements/sensor readings, which may allow for system adjustments to occur in an orderly, predictable manner.

To coordinate this, some embodiments may include a scheduler component, which may be used as part of an F-C process according to some embodiments, and may transfer information between the sub-equations and the general F-C equation. It may regulate how sub-equation data is sequenced and applied. In some embodiments, the scheduler may also add a channel tag which may identify the output as coming from a specific sub-equation—which may be used in downstream processing operations.

According to some embodiments, a scheduler may be or may include a hardware implemented computerized system (such as for example a system according to FIG. 1), and may include a timing subsystem or mechanism configured to initiate periodic execution of sensor-data-acquisition and F-value computation operations. In some embodiments, the scheduler may operate as a deterministic timing mechanism which, at predefined intervals, may: retrieve sensor outputs from one or more data-collection interfaces, convert the retrieved physical-quantity values into corresponding R-unit values, and update the C value used in the F-C computation pipeline. In some embodiments, the scheduler may not be configured to apply rule logic and is not configured to generate actuator-control commands, but rather may provide periodic triggering of the F-computation process. According to some embodiments, an RTC module may be implemented as a distinct rule-execution component configured to receive the updated F value produced by the scheduler-initiated computation and, based on engineer-defined rules stored in memory, generate one or more control instructions for an actuator of the controlled system. In certain embodiments, the scheduler and/or RTC may be implemented as software modules, firmware routines, hardware logic circuits, or any combination thereof, executing on a common processor or on separate processing units within the same computerized system, such that the scheduler provides periodic computational updates while the RTC provides rule-based control-instruction generation in response to the updated F value. In some embodiments, the RTC may receive the current F value directly from that computation and may apply engineer-defined rules to generate actuator control instructions without requiring intermediate storage.

In some embodiments, the scheduler may receive sensor data, for example, via a hardware-level data-acquisition path that includes an analog-to-digital conversion stage (“ADC”) and a digital transport interface such as an Inter-Integrated Circuit bus (“I²C”), a Serial Peripheral Interface bus (“SPI”), a Peripheral Component Interconnect Express memory-mapped input/output region (“PCIe-mapped MMIO”), or a Universal Asynchronous Receiver-Transmitter channel (“UART”), each configured to deliver timestamp-aligned samples into a scheduler-accessible buffer or register file. In some embodiments, the scheduler may poll or be interrupt-driven by a sensor-interface controller, retrieve 10-bit, 12-bit, or 16-bit quantized measurement frames from a memory-mapped first-in-first-out buffer (“FIFO”) or from a direct-memory-access stream (“DMA”), and for example forward such digitized samples to the R-unit conversion module for updating the C value used in the F-C computation, computing an F value (e.g., by subtracting C from R, see for example Eq. 1), and eventually altering or changing the state of the system by an RTC module. Additional or alternative hardware implementations may be used in different embodiments.

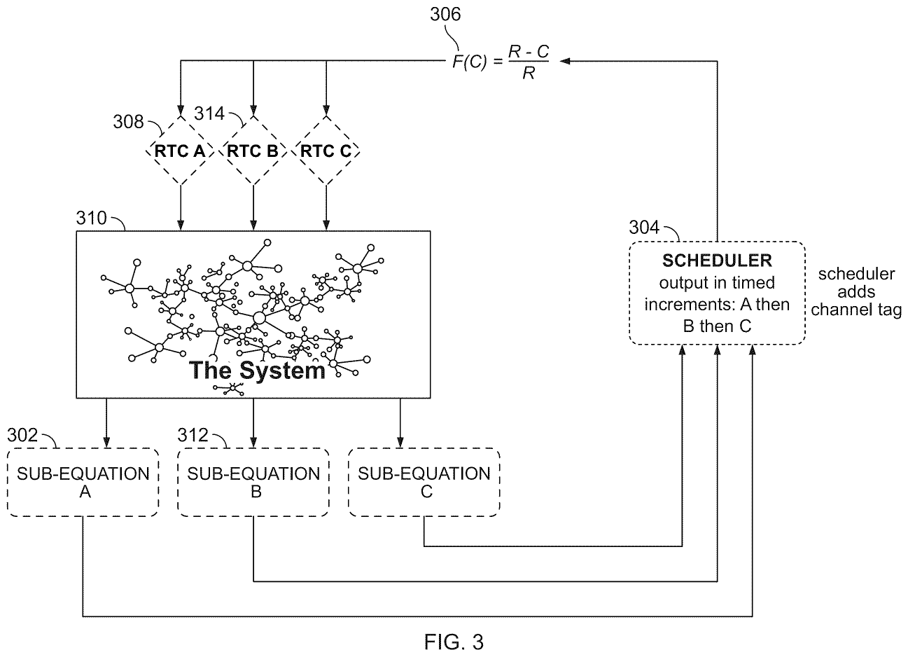

FIG. 3 illustrates an example automatic calibration system including a scheduler according to some embodiments of the invention.

Some embodiments may adjust the use of a resource by the physical system, wherein the adjusting includes for example: balancing the computed freedom value with respect to the subtracted constraint value, and altering a state of the physical system based on the balancing.

For example, data from Sub-Equation A 302 may be read by scheduler 304 at controlled intervals (e.g., once every 10 milliseconds). Upon reading data from Sub-Equation A 302, scheduler 304 may send the resulting R-value together with a channel tag into the Freedom-Constraint equation 306, which may be used in determining or updating the value of C, or the constraint value determined for the current iteration. The updated, newly-determined C value may, in turn, be subtracted from resource value R, to compute a freedom value F (see Eq. 1). Because the newly computed F-value carries a channel tag identifying it as originating from or as used by Sub-Equation A 302, the new or updated F-value may be read by RTC mechanism A 308. RTC A 308 may then apply its associated rule to the newly computed F value; may adjust constraints on the system (and, accordingly, the use of resources by the system); and may update or alter the state of the system 310 in real time-such that new C and F value may be calculated for the altered state. In this manner, an embodiment may balance freedom and constraint, or balance the computed F value with respect to the C value subtracted from R. As noted herein, different embodiments of the invention may not rely on or utilize a sub-equation based architecture: embodiments and nonlimiting examples referring to such an architecture should be considered nonlimiting.

A nonlimiting example illustrating RTC rule and actuator adjustment, as well as balancing freedom and constraint according to some embodiments of the invention, is provided in Table 4:
Nonlimiting Use-Case Example: Variable-Speed Fan Control
Measured sensor value:
Current temperature=84° C.
Defined temperature range for mapping:
0-120° C.
Defined R-unit scale:
0-100 R-units
Example internal control scale mapping function:
R-unit value=(Temperature/120)×100
Substitute measured value:
R-unit Value=(84/120)×100=70

The measured temperature of 84° C. is therefore represented internally as 70 R-units.

That R-unit value may be assigned to or substituted for C in the F-C equation:
C=70
Compute freedom:
F=(R−C)/R
F=(100−70)/100=0.30

Under current measured conditions, 30% of the defined resource (e.g., electric power provided to the fan) is unconstrained.

### RTC Rule and Actuator Adjustment

The RTC may receive the computed F value.
Predefined rule:
Fan drive command=100×(1−F)
Substitute:
Fan Drive=100×(1−0.30)=70%

The RTC may issue a corresponding instruction or control word (such as, e.g., a 70% drive instruction, which may be, e.g., a digitally encoded control signal specifying the commanded drive level—such as a target voltage, current, or pulse-width-modulated duty cycle) to the voltage regulator controlling the fan motor, thereby altering a state of the system (e.g., its speed or drive) and changing its use of the resource (for example, increasing power consumption as the fan's speed increases).

As fan speed increases, cooling increases. On a subsequent timed update (e.g., t second after voltage adjustment), a new temperature measurement may be taken. If the temperature decreases, the mapped R-unit value decreases, C decreases, F increases, and the RTC may correspondingly reduce fan drive.

### Operational Meaning of Balancing Freedom and Constraint

Balance may refer to the condition in which the value of C being subtracted from R is continuously or repeatedly adjusted so that F remains within a defined operating range relative to R. Balance is the ongoing adjustment of constraint (C) relative to resource (R) so that the computed freedom value (F) does not drift toward either extreme, or toward the upper or lower bounds of its defined scale (see, e.g., nonlimiting example in Table 1 where the state of a system is altered to balance temperature constraints with the corresponding freedom value computed using these constraints, thereby adjusting the use of the power provided to the fan, e.g., by sending commands from an RTC module to a voltage regulator controlling fan speed).

### Channel Tag

According to some embodiments, each sensor data stream (e.g., temperature measurements) may be associated with an identifier (also referred to as “channel tag”). The scheduler may assign this identifier to the data stream, for example, upon receiving a new reading and/or prior to passing the computed F value to the RTC. The RTC may use the tag to apply the appropriate rule set for the corresponding actuator.

### Table 4

Some embodiments may iteratively repeat the determining of the constraint, and the adjusting of the use of the resource by the physical system.

In some embodiments, scheduler 304 may be used, for example, when more than one sub-equation is incorporated into an F-C process, since proper sequencing may prevent conflicts (including, e.g., different RTC channels reading the equation asynchronously) and may keep an example system orderly. In one nonlimiting example (pertaining to load balancing in machine learning or artificial intelligence model inference), the F-C process may cycle through multiple iterations, for example, with three sub-equations, each reading a different aspect of the system. Some nonlimiting example operations which may be performed in this example are provided in Table 5:
1. Sub-Equation A 302 may be used in the process to measure an operational variable (such as, e.g., a thermodynamic load) and, using a mapping function, converts it into units of R.
2. Sub-Equation A 302 may be used by scheduler 304, and may share its output or R-value with the scheduler 304 continuously, updating it with each cycle.
3. At the programmed interval, the scheduler 304 may read the current R-value from Sub Equation A 302 and may feed it into the F-C equation 306 to determine an updated value of C.
4. The updated C-value may be input to the F-C equation 306 (which may be used by scheduler 304 or a different computer processor running the F-C process) to compute a new F-value.
5. RTC-A 308 may periodically (e.g., every X seconds) read the current F-value. Upon detecting a matching channel tag, it may apply a dedicated (e.g., predefined) rule, which may trigger a constraint adjustment in the system.
6. RTC-A's action may modify the system 310 by applying or adjusting a constraint, which adjusts the use of a resource by the system: the freedom F to do work using R is either amplified or attenuated according to the RTC's Rule.
7. The scheduler may advance to the next Sub-Equation B 312, and the process may proceed to the next iteration or cycle, where the cycle repeats (e.g., from operation 1, only for Sub-Equation B 312) across multiple iterations. The scheduler may cycle or iterate through all the Sub-Equations in round-robin order for as long as the system is operating.

### Table 5

A nonlimiting example of conflicting reads and their prevention according to some embodiments is provided in Table 6:

In a multi-channel system, more than one constraint loop (including, e.g., reading sensor data, computing F, providing a computed F value to an RTC module, and the like, to adjust or alter the state of the system by balancing freedom and constraint) may act on the same actuator.

For example, in a GPU:

Constraint Loop A (thermal) may determine that temperature is rising and issue a rule: reduce clock speed (the system's state being altered) by 100 megahertz (MHz).

Constraint Loop B (throughput) may determine that utilization is low and issue a rule: increase clock speed by 50 MHz.

(These changes to the GPU's clock speed state may accordingly adjust the use of a resource provided to the GPU (namely, the electric power supplied to it), as greater/lesser amounts of that resource will be used for performing computations (see other nonlimiting examples herein). Different system states may be considered in different embodiments.)

If both rules were executed simultaneously, contradictory actuator instructions may occur. Some embodiments may prevent this, e.g., in for example three ways:
1. Round-Robin Scheduling: Constraint loops A, B, and C may be processed sequentially, not simultaneously. Only one loop may update an actuator during a given scheduler interval.
2. Settling Interval: The scheduler may enforce a predefined delay or time period (e.g., of t milliseconds) between loop executions, allowing the system's thermodynamic state to stabilize before the next constraint update is computed.
3. Shared-Actuator Rule: In cases multiple constraint loops reference the same actuator, the associated RTC may include an engineer-defined channel priority or arbitration rule, such as, for example:
Thermal constraint overrides throughput constraint; or
Clock adjustments are bounded to ±25 MHz per cycle; or
Upward clock changes are disallowed while thermal constraint remains active.

Requiring actuator updates to be sequential, time-buffered, and governed by explicit RTC arbitration rules would prevent applying conflicting constraint instructions (such as, e.g., RTC commands or control words) simultaneously. Destructive oscillation between system states may thus be prevented.

### Table 6

Additional or alternative operations or conflict-prevention mechanisms may be used in different embodiments.

According to some embodiments, each sub-equation may be used in an F-C process to express R in the terms of its own domain—for example, if Sub-Equation A 302 is used to measure temperature, R may represent thermal headroom; if Sub-Equation B 312 is used to measure cycles per second, R may represent processing capacity. Thus, the use of each sub-equation may govern a different aspect of the system, for example, by defining R within its specific thermodynamic domain (or a different domain)—or may represent the system as a whole. Each sub-equation may be used to measure different aspects or quantities of system 310 (including thermodynamic quantities as well as quantities such as, e.g., throughput, latency, etc.) and may be coupled with its own RTC component or mechanism (e.g., RTC-B 314 for Sub-Equation B 312, and the like).

In some embodiments, a scheduler may enforce an interval (e.g., of 10 milliseconds) between successive reads of data associated with and/or outputs provided from a single sub-equation. According to different embodiments, the interval may be predetermined, adaptive, and/or derived from the operating characteristics of the system.

Modern AI systems may blend sequential and parallel operations. For example, AI inference requests may be processed in batches, allowing many computations to proceed in parallel. If two sub-equations are used to act on independent resources (say, thermal vs. network bandwidth), their RTCs may both be adjusted simultaneously or in parallel—and no conflict between sub-equations or measurements may arise. If they both act on the same resource (e.g., if they operate within a single GPU), the scheduler may force them to run sequentially (the general rule or logic may be: parallel when independent; sequential when shared). For example, if Sub-Equation A is used to measure heat, its domain may include everything that changes temperature—voltage, current, cooling flow, thermal resistance, and so on. If Sub-Equation B is used to measure cycles per second (cps), its domain may include everything that determines clock frequency—oscillator, voltage regulator, scheduler timing, etc. These domains may be considered as overlapping—because both depend on voltage and power; adjusting one can affect the other. By contrast, sub-equations that may be used to control unrelated mechanisms—such as thermal load versus network latency—operate in separate domains and can run in parallel. Additional or alternative sub-equation or sensor data processing workflows may be used in different embodiments.

In the nonlimiting use case scenario of AI inference, sub-equation A may be used to measure the GPU's thermal load, defining R as available heat capacity. Sub-equation B may be used to track compute utilization, defining R as available processing cycles. Sub-equation C may be used to monitor data transfer between GPUs, defining R as effective network throughput. Each Sub-Equation may be used (e.g., by a processing unit or scheduler component executing an F-C process) in real time within its own thermodynamic domain, and they may be balanced and/or calibrated to keep the system stable and efficient. The Freedom-Constraint equation and process may provide this balance. Some embodiments may adjust not only when to act, but how strongly each thermodynamic domain may be weighted at a given moment.

A nonlimiting example time control process is provided in Table 7:
1. Measurement—Sub-Equation A may be used to detect conditions in its domain (for example, temperature) and map them into R-units.
2. Sequencing—The scheduler may read the current R-value and may feed it into the F-C equation (which may be managed or executed by the scheduler as part of the F-C process) in strict order.
3. System Balancing—Each update may cause a quantifiable change in F, which in turn may be used to adjust how strongly that domain's constraint is applied within the system.
4. Constraint and Balance—The F-C equation may be used to recalculate or compute F (by subtracting a constrain value C from a resource value R), producing a quantifiable change in the strength of RTC-A's constraint.
5. Advance—The scheduler may advance to Sub-Equation B and may repeat the process, cycling through all sub-equations in round-robin order, and the cycle repeats.

By iterating or repeating this cycle, the system may continually redistribute weight across domains. A sudden spike in GPU temperature, for example, may immediately be given greater priority, while other factors may recede until balance is restored.

### Table 7

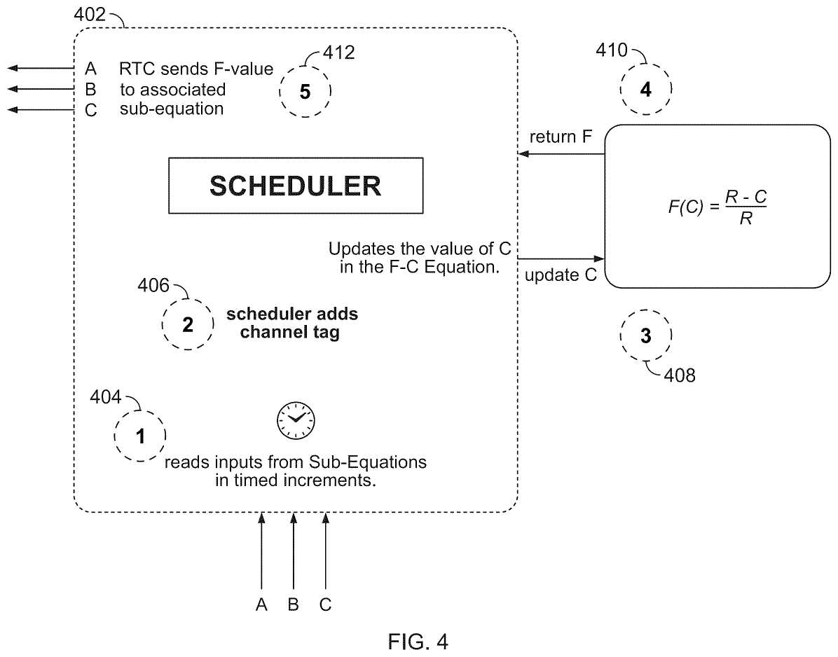

FIG. 4 illustrates an example scheduler unit according to some embodiments of the invention.

A scheduler unit 402 may coordinates the timing and sequencing of the use of sub-equations and the availability of data resulting from sub-equations. It may determine when each sub-equation's data/output is read, how that data may be used to update the Freedom-Constraint equation, and when the resulting F-values are made available to the associated RTCs, e.g., through a scratchpad. An example workflow executed by scheduler unit 402 is provided in Table 8:
1. Scheduler 402 reads inputs from each sub-equation at scheduled intervals (operation 404).
2. For each sub-equation, it adds a channel tag (operation 406).
3. It then updates the value of C in the Freedom-Constraint equation, causing the corresponding value of F to change (operation 408).
4. Scheduler 402 then returns the changed or updated F value (operation 410) advances to the next sub-equation and repeats the process.
5. The returned F value may be sent or passed to a corresponding RTC component or unit to calibrate or adjust the system in the relevant domain (operation 412).

### Table 8

The Scheduler may thus function as the system's timing and coordination module, ensuring that all sub-equations are read, tagged, and entered into the F-C equation in a controlled sequence—without conflict or overlap. Additional or alternative scheduler operation workflows may be used in different embodiments.

As used herein, an RTC Rule may refer to an engineer-defined specification set which may be implemented in a dedicated software module executed by a scheduler component or a different processing unit, which may be written together with an associated Sub-Equation, that defines the system's Resource (R) and establishes how a constraint acts on the system's freedom to use that Resource to perform work. A rule may establish, e.g.:

What R is—defining the resource (R) that is being managed. For example, if Sub-Equation A is used in an F-C process to measure heat, the paired Rule in RTC-A may define the Resource as computing work expressed through thermal load. If Sub-Equation B is used in an F-C process to measure network latency, the paired Rule in RTC-B may define the Resource R as data throughput expressed through delay.
What type of constraint (C) is to be applied to the use of resources under given conditions. It may set the thresholds or ranges at which constraint may increase or decrease, e.g., based on live data from the Sub-Equation. For example, if Sub-Equation A is used in an F-C process to measure heat, the paired RTC-A Rule may specify how computing speed should begin to taper as temperature rises. If Sub-Equation B is used in an F-C process to measure network latency, the paired RTC-B Rule may specify how data transmission may be rerouted as delay increases.
A trigger condition—each Rule may define the condition under which a constraint is activated. The trigger may monitor these conditions and may execute a corresponding action when the defined threshold is met.
According to some embodiments, rules may be static (e.g. human-engineered or predefined) or dynamic (e.g., machine-generated and/or automatically adjusted) depending on whether the system has been designed for adaptive capability. Rules may operate independently or hierarchically depending on the design. RTC rules may be callable objects and may be referenced by Triggers.

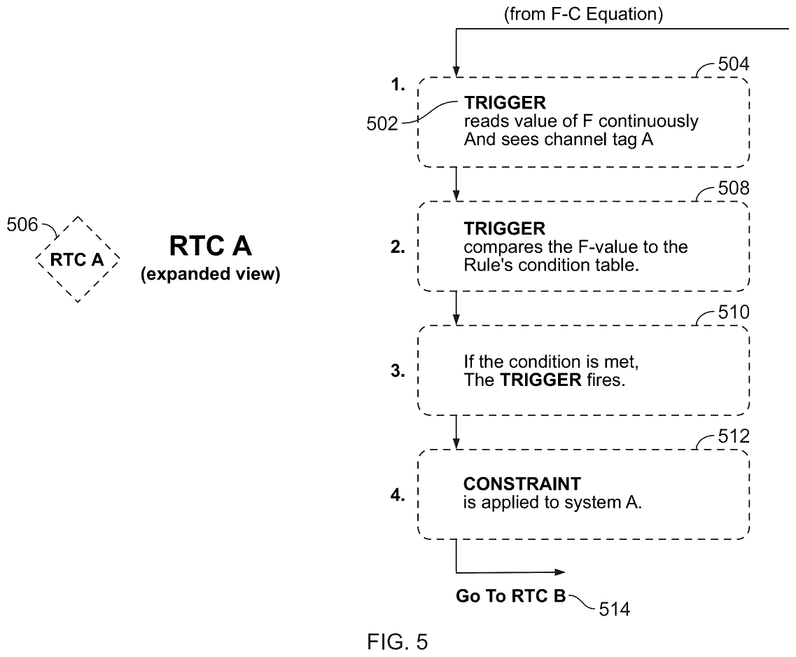

As used herein, an RTC Trigger (such as, e.g., trigger 502 in FIG. 5, which may be for example a software module executed by a processor-such as, e.g., a scheduler component) may refer to an RTC's event handler. It may watch for changes in the live F-value, may evaluate them against the Rule's condition, and may fire when the condition is met. An RTC trigger may, for example, READ the current value of F from the F-C Equation; COMPARE that value to the condition(s) in the associated Rules; and ISSUE or WITHHOLD an instruction to apply the corresponding constraint(s). The Trigger may not interpret or modify the Rule; it may simply automatically execute the specified action when the condition is met.

For example, the Trigger in an RTC-A may continuously monitor the live value of F associated with Sub-Equation A. When F crosses a threshold defined in the Rule, the Trigger may fire, activating a constraint specified for that condition.

As used herein, an RTC may refer to software and/or hardware modules inducing or contributing to an operational change in how much a rule subtracts from usable potential R. The subtraction may be positive or negative—reducing or increasing the system's ability to use its resources. A constraint may act when instructed by its Trigger. Once activated, it may adjust the usable portion of R—attenuating or amplifying the system's freedom (F) to use its resources to perform work. According to some embodiments, constraints may be implemented in, e.g.: 1. Discrete Adjustments—use fixed or table-based values applied at specific thresholds; and/or 2. Continuous Adjustment—use a mathematical function or curve applied over time. Additional or alternative constraint forms may be used in different embodiments.

After a Constraint is applied, the system's physical or informational state (and, consequently, the use of the resource by the system) may be altered or changed. The new state may then be measured by the relevant Sub-Equation in the next cycle, producing an updated R-value, which in turn may generate a new value of F through the Freedom-Constraint equation. Thus, F may always represent the system's current operational freedom after the most recent constraint has taken effect—it may be a continuously recalculated value that reflects the system's current, live state.

FIG. 5 illustrates an example operation workflow of a Rule-Trigger-Constraint (RTC) module according to some embodiments of the invention.

According to some embodiments, each RTC module or mechanism may correspond to one Sub-Equation in the system. The Scheduler may update the Freedom-Constraint equation in a timed sequence, and apply channel tags that identify the source Sub-Equation causing the update. Each RTC's Trigger may monitor the F-C equation for its matching tag, may read the corresponding F value, and may then operate autonomously according to its Rule and Trigger conditions.

Some nonlimiting RTC operation workflows are described in Tables 9-11:
1. Read: RTC-A Trigger 502 continuously reads current F-value from the F-C equation. When it sees channel tag “A,” the trigger 502 reads the corresponding F-value (operation 504), and . . .
2. Compare: . . . RTC-A 506 compares the F-value to the Rule's condition table (operation 508).
3. Match: If the condition is met, the Trigger fires (operation 510), and . . .
4. Constraint: . . . the Constraint is executed, either attenuating or amplifying the system's ability to use its Resources to do work according to the specifications in the Rule (operation 512).

The cycle then advances to Sub-Equation B and repeats in a similar fashion (operation 514).

### Table 9

### Detailed RTC Operation—Variable-Speed Fan Example

This nonlimiting example shows how the RTC applies a rule, alters the physical state of the system, and produces measurable thermodynamic change.

### System Definition

Resource (R): Electrical power supplied to the fan motor.
Maximum available power=100 R-units (engineer-defined scale).
Measured temperature: 84° C.
Reference temperature: 80° C.
Engineer-defined mapping function:
84° C.→40 R-units
Thus:
C=40
Compute freedom:
F=(R−C)/R
F=(100−40)/100
F=0.60

The RTC receives F=0.60.

### RTC Rule

The RTC receives the computed value F=0.60. During its execution cycle, the RTC reads this digital value and compares it to the engineer-defined rule conditions. The processor may perform a standard numerical comparison, and may, based on the result, select the corresponding actuator instruction.

### Constraint Action (or RTC Commands) Taken: Example 1

Assume the following predefined RTC rules:
1). If F is 0.50 or lower→Fan Drive=70%
2). If F is between 0.50 and 0.65→Fan Drive=50%
3). If F is between 0.65 and 0.80→Fan Drive=30%
4). If F is above 0.80→Fan Drive=15%
(Higher temperature→higher C→lower F;
Lower F=system is hot.
Lower temperature→lower C→higher F;
High F=system is cool.)

In this example:
F=0.60

The RTC therefore compares 0.60 to the rule set, selects Rule 2, and issues an RTC command or control word to adjust or alter the system's state (e.g., as reflected in voltage and/or fan drive) according to the rule (see also nonlimiting example in Table 1).

For instance, the RTC may send a 50% drive command to the fan actuator. The actuator may then increase electrical power delivered to the fan motor. The fan may spin faster, increasing airflow and removing heat from the system.

### Constraint Action Taken: Example 2

Instead of using a step-based table, the engineer may define a continuous rule such as: Rule:
Fan Power Setting (%)=100×(1−F)
Case 1:
F=0.60
Fan Power=100×(1−0.60)
Fan Power=40%
Case 2 (next cycle, cooler):
F=0.70
Fan Power=100×(1−0.70)
Fan Power=30%
Case 3 (hotter):
F=0.45
Fan Power=100×(1−0.45)
Fan Power=55%

Fan power increases as F decreases. As F changes smoothly from cycle to cycle, the fan drive may change smoothly as well. The relationship is continuous rather than step-based (as also shown in the nonlimiting example provided in Table 1).

### Table 10

### How This Example Reflects Balancing Freedom and Constraint

In the nonlimiting example provided in Table 10, Constraint (C) may represent the portion of available electrical power to be limited to prevent overheating.

Freedom (F) may represent the portion of available electrical power that remains available for productive operation (e.g., using the resource to perform work).

As temperature rises, C increases and F decreases. The RTC responds by increasing fan power (namely, altering the state of the system), and changing electrical power use (or the use of a resource by the system)—which removes heat and prevents the system from drifting toward thermal failure.

As temperature falls, C decreases and F increases. The RTC reduces fan power (or alters the fans state), preventing unnecessary cooling and wasted energy (thereby adjusting the use of the resource—electric power—provided to the system).

In this way, freedom and constraint are being balanced: constraint is continuously adjusted relative to the freedom to use the resource. The system is kept within a stable operating range rather than drifting toward either overheating or excessive constraint.

### Table 11

Additional or alternative operations may be performed in different embodiments.

According to some embodiments, each Sub-Equation may be used to measure the updated thermodynamic state of the system; convert that measurement into R-units; and send the new value to the Scheduler for the next cycle or iteration. When multiple RTCs operate within the same system, each calibration loop may run independently but remain synchronized by the Scheduler to prevent conflicts.

In some nonlimiting example use cases, small drop in constraint may unlock a huge new range of freedom—or a small gain in freedom may require exponentially greater reductions in constraint. This non-linear behavior may be referred to as “asymmetrical calibration”. For example: if a GPU gets hot and is about to fail, an exponential cooling function may be used. As a GPU nears its thermal limit, a linear constraint response cannot cool it fast enough. The system may switch to an exponential constraint function, throttling frequency or power non-linearly to prevent failure. In such cases, some embodiments may use mapping functions that translates, e.g., a 1:1 F-C relationship (as expressed, e.g., in Eq. 1) onto a different curve (exponential, logarithmic, sigmoid, etc.) needed to prevent failure. According to some embodiments, nonlinearities may be expressed or addressed via RTC rules (while keeping the F-C equation in a standard, linear form). Some embodiments may dynamically switch between linear and nonlinear equations and calibration modes as conditions evolve, maintaining equilibrium as internal dynamics change.

In some embodiments of the invention, Sub-Equations and their associated RTCs may be used in an F-C process at the general or specific level—or using general or specific tuning. General Tuning may occur, e.g., when a Sub-Equation/RTC pair is used as part of an F-C process to measure and regulate the same R that the entire system uses. Specific Tuning may occur, e.g., when a Sub-Equation/RTC pair is used as part of an F-C process to measure and regulate an R that applies only to its local subsystem. General tuning may be selected or may be preferred, e.g., when global stability matters most. Specific tuning may be selected or may be preferred, e.g., when local precision or speed matters most.

In General Tuning according to some embodiments of the invention, each Sub-Equation and its paired RTC may contribute to maintaining the overall optimization of the system or its global efficiency. In this case, the R-units produced by each Sub-Equation may be the same as those that define the system as a whole. The Resource (R) may be described as the physical system's overall Performance per Watt (PPW). Nonlimiting Example 1: In AI inference, a Sub-Equation may be used to measure GPU temperature. It may convert that thermodynamic property into R-units representing the Performance per Watt of the entire inference system. The Sub-Equation may be used to constrain temperature to maintain or increase overall PPW. Nonlimiting Example 2: Another Sub-Equation may measure available bandwidth. It may convert that measurement into the same R-units—Performance per Watt (PPW)—and its constraint on data flow may also affects the PPW of the entire AI inference system.

Some nonlimiting example implications of general tuning are described in Table 12:
Stability: General Tuning may minimize oscillations or runaway conditions because all Sub-Equations may express their outputs in the same R-units and act through a shared global constraint. This unified feedback promotes homeostasis, provided that the interval between constraint events is long enough for the system to dissipate transient effects before the next correction begins.
Slower Responsiveness: Response times may be slower, not because Sub-Equations see the big picture, but because their combined effect may be averaged through a global constraint that adjusts more slowly.
Best for Low-Volatility Systems: General Tuning may be ideal for environments where conditions change gradually or predictably—such as, e.g., data centers and ecosystems.

### Table 12

In Specific Tuning according to some embodiments of the invention, each Sub-Equation and its paired RTC may be used to contribute only to maintaining the optimization of its own sub-system or its local efficiency. Each pair may measure and regulate the Resource that defines the sub-system, so its adjustments may affect only that aspect of system performance. For instance, in AI inference, two nonlimiting examples may illustrate Specific Tuning in discrete domains. Nonlimiting Example 1 (thermal domain): a Sub-Equation may be used to measure temperature. It may convert that measurement into R-units, where R is the current temperature of the compute domain. The paired RTC may apply constraints to power to manage heat within this domain, without changing other system functions. Example 2 (data-flow domain): a Sub-Equation may be used to measure data flow (rate and delay). It may convert that measurement into R-units where R may be the current data-transfer rate. The paired RTC may apply constraints to pacing/batch size to keep flow efficient within this domain, without changing other system functions. Each Sub-Equation/RTC pair may operate locally, maintaining balance within its own thermodynamic area of performance without altering the rest of the AI inference system.

Some nonlimiting example implications of specific tuning are described in Table 13:
Localized Optimization: Specific Tuning may enable fine-grained control because each Sub-Equation/RTC pair acts directly on its own variable. Adjustments may occur at the source of the condition rather than through averaged global feedback.
Direct Cause-and-Effect Clarity: Because each Sub-Equation/RTC loop may govern only one factor, its influence on system behavior may be observed immediately. This separation of variables may allow to isolate effects, test adjustments, and refine mappings with precision.
Higher Responsiveness: Specific loops may react in near real time to micro-changes within their own factor—such as, e.g., a temperature rise or bandwidth fluctuation. This may reduce lag and transient losses, maintaining efficiency.

### Table 13

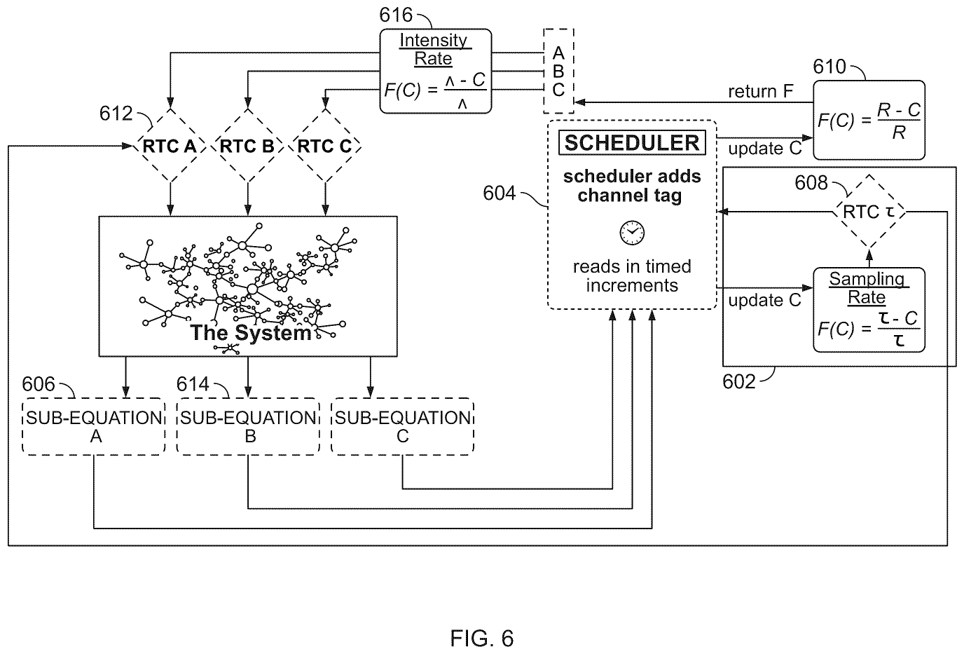

FIG. 6 illustrates an example automatic calibration system including tau and lambda loops according to some embodiments of the invention.

In addition to components/modules described with reference to FIG. 3, some embodiments may include a tau loop module 602 for adaptive timing control. This module may regulate the timing of constraint updates. When a system becomes unstable, the rate at which the Freedom-Constraint process recalibrates may be dynamically adjusted to compensate, regaining stability. A faster recalibration rate may enable the system to correct itself more often, restoring stability more quickly. A slower rate may reduce activity, conserve energy and lower operating cost.

A timing module—which may also be referred to as the “Tao Loop” 602—may include or use an equation in a mathematical form similar to the main F-C Equation, reflecting a recursive relationship. This similarity or repetition may indicate that the same governing ratio of usable freedom to an applied constraint may operates at multiple levels of the system. Where F is Freedom, and C is Constraint, Tao (τ) may denote maximum throughput, where 0<C<τ.

Accordingly, in some embodiments, the adjusting of the use of the resource by the physical system comprises, across one or more iterations, determining a timing for applying the constraint to the resource. Some nonlimiting example operation workflow of tau loop module 602 is described in Tables 14-15:

### Operation 1—Scheduler Sends Input to the τ-Equation

The scheduler 604 reads the current R-value from Sub-Equation A 606 and forwards it to the Adaptive Timing module (Tao loop 602) by writing the current constraint value (C) into the τ-equation.

The variables in the τ-equation may be assigned as follows:
τ (Tao)=the theoretical maximum constraint rate or timing—the ideal (or fastest) tempo at which the F-C loop may operate and change the state of the system (e.g., once every compute cycle in an AI inference system).
F (Freedom)=the system's current freedom to use the F-C loop to change the state of the system—how close the actual operating constraint rate is to τ (ideal freedom).
C (Constraint)=The amount of slowdown applied to or determining the F-C loop's constraint rate or timing. A higher C may bypass the next FC cycle and/or iteration; a lower C may allow it to proceed. When C increases, the rate or timing of the application of the relevant constraint may slow down. When C decreases, the rate or timing of the application of the constraint (and the altering of the state of the system) may accelerate.

### Operation 2—Use of Tao Equation

With a new value entered into C, the τ-equation may calculate or determine:
(Eq. 2) F(C)=(τ−C)/τ; where 0<C<τ

The resulting F-value may represent the system's current freedom with reference to the rate or timing of applying the constraint—how closely the actual operating rate is approaching τ.

### Operation 3—τ-RTC Evaluation

The τ-equation may have its own lightweight RTC dedicated to timing control (e.g., RTC-τ 608). In some embodiments, unlike the larger RTCs associated with the main F-C loops, this RTC-τ 608 may perform only a simple comparison function—reading the F-value and checking it against a stability condition defined in its Rule. The Rule itself may be set, e.g., manually, by the system's designer, who may determine, through testing or operational experience, what numerical ranges correspond to stable or unstable behavior for the system.

### Operation 4—Routing Decision

If Fτ (the Freedom value from the τ-Equation) is unstable according to the rule implemented in RTC-τ 608, then RTC-τ 608 may route Fτ back to the scheduler 604. The scheduler may then update C in the Tao equation and/or the main F-C Equation 610 to determine a different rate or timing for applying the constraint to the resource and may initiate a full recalibration cycle, resulting in a change of timing or rate of applying constraints across iterations (starting from the iteration following the computing of a new constraint rate).

If Fτ is stable according to the Rule, then RTC-τ 608 may bypass the F-C equation entirely and may send Fτ directly to RTC-A 612, maintaining the current state. This may keep the system in a low-activity condition and may conserve energy.

### Operation 5—Repeat

The main F-C process may advance to the next cycle Sub-Equation B 614 and may repeat the above operations, or a different series of operations, across multiple iterations.

### Table 14

In the following example, assume an F-C loop is running at a nominal or maximal rate of 1,000 cycles or times per second (1,000 Hertz (Hz)). The τ (Tao) loop may measure the actual execution rate or timing of this inner or “main” F-C loop using the system clock (which may be, e.g., a timing signal generated by a hardware clock source that governs the switching rate of the system's logic circuits and determines the number of computational operations the system can perform per unit time). Sustained deviation from the defined maximal rate or timing may indicate inefficiency in the underlying process.

The 1,000 Hz rate may be a maximum allowable calibration rate or timing (as may be predefined or prespecified, for example, by the system designer). The actual sustainable operational maximum of the system may be higher or lower, and may emerge from live system behavior.

The τ loop may read timing data from the system clock. While timing data is not a thermodynamic measurement such as, e.g., temperature or voltage, it may indicate that the underlying physical system may be working inefficiently.

The τ scheduler may read the actual execution rate or timing of the inner F-C loop from the system clock—for example: 965 Hz, 958 Hz, 962 Hz, 955 Hz, 960 Hz, 957 Hz, 963 Hz, 959 Hz, 961 Hz, and 956 Hz. These ten timing samples may be stored in a memory buffer and may be averaged.

The τ buffer may accordingly compute an average rate of 960 Hz.

### Case/Iteration 1:

Rτ=1000 (maximum allowable rate defined by the engineer)
Observed average rate=960 Hz
Cτ=Rτ−Observed Rate=40
Compute:
Fτ=(Rτ−Cτ)/Rτ
Fτ=(1000−40)/1000
Fτ=0.96

The τ-RTC may compare Fτ to its threshold rule and may allow the inner, or main F-C loop to execute during the next cycle, thereby determining that an RTC module may issue calibration commands or control words to apply constraints to resources and alter the state of the system according to F-C loop logic.

### Case/Iteration 2:

In a separate interval, the τ scheduler may read the following ten samples: 999 Hz, 1001 Hz, 998 Hz, 1000 Hz, 1002 Hz, 999 Hz, 1000 Hz, 1001 Hz, 998 Hz, and 1000 Hz. The buffer may then average these values to approximately 1,000 Hz.
Rτ=1000 (maximum allowable rate defined by the engineer)
Observed average rate≈1000 Hz
Cτ=Rτ−Observed Rate=0
Compute:
Fτ=(Rτ−Cτ)/Rτ
Fτ=(1000−0)/1000
Fτ=1.00

The τ-RTC compares Fτ to its rule and skips the next inner F-C calibration cycle.

In this manner, by skipping or allowing F-C iterations to proceed—the tao loop and τ-RTC may determine rates or timings for applying constraints to resources (namely, the times where main F-C loop iterations are allowed to execute) and for subsequent altering of system states.

### Table 15

Additional or alternative rate or timing determination operations may be used in different embodiments.

According to some embodiments, the τ-equation may introduces adaptive timing, or adaptively determining rates or timings for applying constraints to the system, and to altering the state of the system—a self-regulating control mechanism that may tie the system's constraint rate directly to its thermodynamic state, mapped into R-units and then expressed by F-C as F-units. Some example implications and significant factors relating to the τ-equation are described in Table 16:
Thermodynamic Basis: The τ-equation expresses timing adjustment as a ratio: F(C)=(τ−C)/τ, linking the rate of constraint directly to the thermodynamic state of the system. Frequency of constraint therefore becomes a physical measure of stability—a new form of dynamic calibration factor that has not been used in previous calibration systems/frameworks.
Stability: Traditional control systems link correction to errors in output, adjusting behavior only after a deviation or error occurs. The Freedom-Constraint (F-C) equation and process—and by extension, the τ-equation that may govern its timing—may link constraints directly to the thermodynamic state of the system. This may improve existing technologies by allowing to maintain stability proactively, rather than reactively.
Universality: Because τ represents the theoretical maximum constraint rate, the same Freedom-Constraint principle—and its timing extension through the τ-equation—may apply across various domains of technological system behavior. This unified calibration process may govern various physical systems, such as, e.g., mechanical, informational, and hybrid systems alike—such as, e.g., NASCAR engines and Nvidia GPUs, AI infrastructure, and Ethereum/blockchain-based decentralized networks—providing a calibration law to produce efficient, self-regulating systems.
Energy Efficiency: By coupling the constraint rate to the thermodynamic state of the system, the τ-equation may automatically conserve energy when conditions are stable and may increase responsiveness only when needed—eliminating idle recalibration cycles and unnecessary computation.

### Table 16

Some embodiments may include a Lambda (Λ) mechanism or module 616 that may regulate the magnitude or intensity of the applied constraint. Whereas the τ-equation may be used to govern tempo or timing (how often the system recalibrates, or how often its state its altered), the Λ-equation may govern amplitude (how much constraint is permissible).

Accordingly, in some embodiments, the adjusting of the use of the resource by the physical system comprises, across one or more iterations, determining a magnitude for the constraint. A nonlimiting example operation workflow of lambda loop module 616 is described in Tables 17-18:

### Operation 1—Scheduler Sends Input to the Λ-Equation

After the scheduler 604 updates the value of C in the main Freedom-Constraint equation 610, it may publish the returned F-value—expressed in R-units—to the Lambda module 616 where it becomes the input constraint (C) in the Λ-equation. The Λ-equation may determine the degree of usable freedom remaining in R as the current amplitude or magnitude of the constraint acting on the system.

The variables in the Λ-equation may be assigned as follows:
Λ (Lambda): the theoretical maximum constraint capacity of the system (the ceiling). It represents the highest permissible constraint magnitude before usable freedom asymptotically approaches zero and the system becomes unstable. This maximum may be defined by the system's physical, informational, or thermodynamic limits.
F (Operational Freedom): the system's current ability to use its resources toward a defined goal. This is expressed as a ratio between F and C—the ratio between the remaining freedom and the applied constraint.
C (Constraint): Quantifies how much a Rule subtracts from the system's Freedom to use its potential R to achieve its defined goal. C may result from natural forces such as torque load, thermal stress, liquidity pressure, network congestion, etc., or from limits established by the system designer.
Formally:
(Eq. 3) F(c)=(λ−C)/Λ; where 0<C<Λ

### Operation 2—Lambda Equation Computes

With a new value entered into C of Λ, the Λ-equation calculates or determines F of Λ. The resulting F value may represent the system's current freedom to amplify or attenuate the magnitude of constraint being applied. In operational terms, F of Λ may express how much headroom remains before the constraint's ceiling (Λ) is reached.

### Operation 3—Λ-RTC Evaluation

The Λ-equation may output the computed F of Λ value to the associated Rule-Trigger-Constraint loop (RTC-A 612). RTC-A may compare the F of Λ value against the numerical ranges defined in its Rule. If a Rule's condition is met, the Trigger may apply the corresponding constraint adjustment (and in this case, determine a magnitude of a constraint applied to the system), if any—either amplifying or attenuating the effect according to the Rule's specification across iterations (such as, e.g., determining a magnitude Mn for a constraint Cn applied in iteration n, where Mn is larger/smaller than Mn-1—the magnitude of the constraint applied in the preceding iteration n-1). The Rule in RTC-A 612 may be written, e.g., by the system's designer, who may determine, for example through testing or operational experience, what numerical ranges correspond to stable or unstable behavior of the system with regard to the magnitude of a constraint applied to it.

### STEP 4—System State Changes

RTC-A 612 may apply its constraint, drawing, e.g., either from a table of static values or from a mathematical function defined in its Rule. Once the constraint is applied, the system's operating state may be adjusted or updated accordingly. The main Freedom-Constraint cycle or loop may then advance to Sub-Equation B 614 and the process may repeat itself.

### Table 17

### Nonlimiting Lambda Loop Example (Fan Goes Up)

### System

A server rack is running. An F-C loop is controlling a cooling fan.

In this nonlimiting example, a system designer defines the numerical range that lambda can have and creates a 0-100 λ R-unit scale, where 100 λ R-units represents the maximum constraint capacity available to the supervisory loop.

After reading sensor data and updating C, the main F-C equation produces a freedom value of F=0.60.

The main RTC applies its rule set and sets fan power to 60%.
Fan=60% power

However, the system is still running hot.

### The Lambda Loop:

The λ scheduler observes the actuator control register of the system. For example, it may read the actuator command values being applied to the fan in timed increments. It may then map those command values into λ R-units and may store them in the λ memory buffer, e.g., over five cycles of the F-C process. The corresponding command values may be, e.g.: 52%, 55%, 54%, 53%, 56%

The five buffered R-unit values may be averaged.
Average=54 λ R-units.

This average may be used as the current λ-constraint value.

Therefore, in the Lambda equation:
Cλ=54 λ R-units.

The Lambda equation may be used to compute the value of Fλ, e.g., according to: F_λ=(λ-C_λ)/λ, 0<C_λ<λ

The Lambda RTC may read the value of Fλ, which may be Fλ=0.46. This value may then be compared to the relevant rule in the Lambda RTC (which may be predefined by a system designer).
Nonlimiting Example λ Rule: If Fλ <0.50, set multiplier Mλ=1.20

(This multiplier may determine a magnitude for a constraint applied to the system in a calibration iteration or cycle of the main F-C loop: for example, it may increase the RTC command or control word by 20%, leading to raising the power supplied to the system from 60% to 72%.)

The multiplier Mλ=1.20 may be sent to the main F-C RTC, to determine the magnitude of the constraint or RTC command applied in the relevant F-C iteration.

The main F-C loop may then compute the adjusted freedom value:
F\hat{ }′=F×M_λ
F\hat{ }′=0.60×1.20=0.72

The main F-C RTC may accordingly apply the adjusted fan command of the determined magnitude of 72%, increasing fan speed, improving cooling, and lowering system temperature as both the F-C and Lambda calibration cycles continue.

### Table 18

Additional or alternative Tao/lambda mechanisms and related operations may be used in different embodiments.

According to some embodiments, another form (referred to as the “P form”) of the Freedom-Constraint Equation may extend the same calibration principle, where the measurable resource may be referred to as a property—the sum of all freedoms to act without interference. In this form, P represents a total property, and C represents interfering actions that restrict or reassign the property:
(Eq. 4) F(C)=(P−C)/P; where 0<C<P
   Additional or alternative expressions or equation forms may be used in different embodiments.

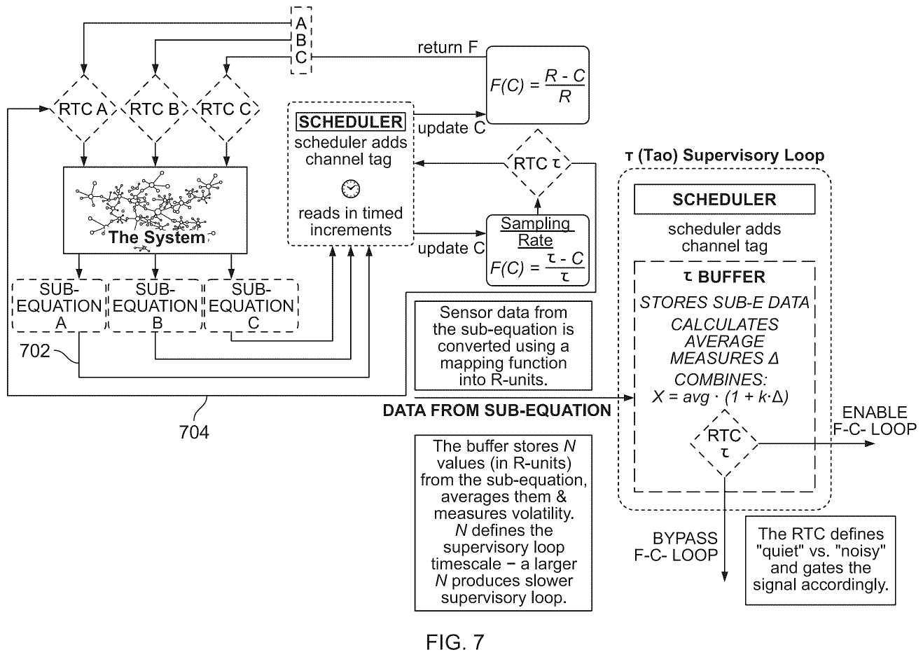

FIG. 7 shows an example automatic calibration system including a supervisory loop according to some embodiments of the invention.

According to some embodiments, Tao and/or lambda loops may be implemented outside the main F-C loop 702, e.g., as supervisory loops 704 that oversee it. In some embodiments, the main F-C loop 702 may be executed at shorter time intervals compared to a supervisory loop 704. In other words, the supervisory loop 704 may be slower than the main F-C loop.

Using the τ loop as an example, the system may be organized as a fast inner F-C loop 702 and a slower supervisory loop 704 that periodically updates C. The fast F-C loop may respond immediately to current system conditions. The slower supervisory loop 704 may aggregate system behavior over time before making an adjustment. This may prevent overreaction to transient noise.

A nonlimiting example process that may be executed by supervisory loop 704 is provided in Table 19:

### An Example Tao Loop Process

1. The scheduler periodically reads data from Sub-Equation A into a memory buffer in supervisory loop 704 (also referred to as a τ buffer).
2. Each reading is stored until the buffer contains N samples.
3. The τ buffer computes the average of the N values and calculates their delta (volatility).
4. The average and delta are combined into a single R-unit value using: x=average·(1+k·delta).
5. This R-unit value updates C in the τ equation.
6. The updated C produces a new value of F.
7. The τ buffer's RTC-τ reads the new value of F and determines whether to:
A) allow the fast F-C loop to continue, or B) bypass the fast F-C loop. If bypassed, the signal is sent to RTC-A.
8. RTC-A applies its rule and advances the signal to Sub-Equation B.
9. The process repeats itself

### Table 19

The τ buffer may slow the supervisory loop 704 relative to the fast inner F-C loop. The value of N may control the speed of the loop: larger N may slow it down; smaller N may speed it up. For example, the τ supervisory loop may run 10× to 100× slower than the inner F-C loop, achieved by setting the value of N accordingly. Supervisory loop 704 may adjusts when the F-C loop is applied, and may not modify any F-C rules in the F-C RTC. A λ (Lambda) supervisory loop may operates using a similar structure and procedure, differing only in the parameter it adjusts. Similar inner-outer supervisory loop configuration may be used for τ and λ and may also be applied to calibrate other aspects of a system, such as for example:
Sensitivity: which may refer to controlling how small a deviation must be before it matters, how much variation (Δ) is ignored as noise, and the granularity with which constraint is adjusted.
Channel Weighting: which may refer to controlling the relative importance of different sub-equations, the order in which RTCs are applied, and whether constraint adjustments have local or system-wide effect.
Memory: e.g., controlling how much past behavior is retained, how quickly older data loses influence, and the separation between entry and exit conditions for applying constraints.
Policy: Controlling default safety bias, emergency override conditions, and whether constraint application may be manually suspended or frozen.

Additional or alternative supervisory architectures may be used in different embodiments.

Modern GPUs include thousands of local compute regions operating in parallel, each with its own thermal and electrical behavior. Dynamic Voltage and Frequency Scaling (DVFS) systems may be used to dynamically manages this behavior, but their coarse, reactive design leaves room for unavoidable inefficiencies.

In some existing GPU systems, (such as, e.g., Nvidia GPUs), thermal and electrical behavior is supervised by a hierarchy of controllers. Sensors measuring temperature and voltage report their readings to dedicated components such as, e.g., a power management unit (PMU) and a system management unit (SMC), which also track the current clock state as they coordinate the device's global voltage and frequency settings. The PMU and SMC receive these readings, briefly cache and average them, then compare the results to the GPU's static lookup tables—the DVFS tables—to decide how to adjust clocks, voltage, and power limits to keep the GPU within safe operating ranges. These readings are sampled at intervals ranging from a few milliseconds to tens of microseconds. The firmware only reacts when an averaged value crosses a fixed point in the DVFS table—the table's values cannot be adjusted. This method works, but it is reactive: the control logic waits until drift (deviation from target value) has already occurred before acting. Because the decisions rely on discrete thresholds, the GPU continually overshoots and corrects, producing oscillation around the target operating point. The result is wasted energy, fluctuating efficiency, and reduced performance per watt. Some embodiments may mitigate or resolve this inefficiency using an F-C calibration process.

Some example F-C variables that may be used for automatically calibrating a GPU system according to some embodiments of the invention are described in Table 20:
R (Resource): Electrical power entering the GPU from its voltage regulators—the energy that can, in theory, be converted into computation. Every watt represents potential compute work.

In an ideal system, all of this energy would become operations per second with no losses. In practice, however, some portion is always limited by thermal, electrical, and timing limits. Those limits are expressed as the system's constraint.
C (Constraint): The operational subtraction from R. It reduces the system's usable energy so the system remains efficient under real physical conditions. C is a variable that changes continuously as conditions on the GPU change.

In a GPU, temperature and voltage readings or states that may be defined by such readings—together with the current clock state—describe the moment-to-moment conditions under which work must be done. These values determine the amount of constraint—how much of R is subtracted at each moment.
F (Freedom): The portion of electrical power that remains usable for compute work after constraint (C) is applied to the resource (R). Because F is a function of C, its value changes from moment-to-moment as conditions on the GPU change.

Ideal freedom would mean 100% of the electrical energy from the voltage regulators is converted into computation—every transistor switching at full speed with no thermal, voltage, or timing limits.

Operational freedom is the actual condition of usable energy—the portion of R still available for computation after constraint is applied in real time. Table 20

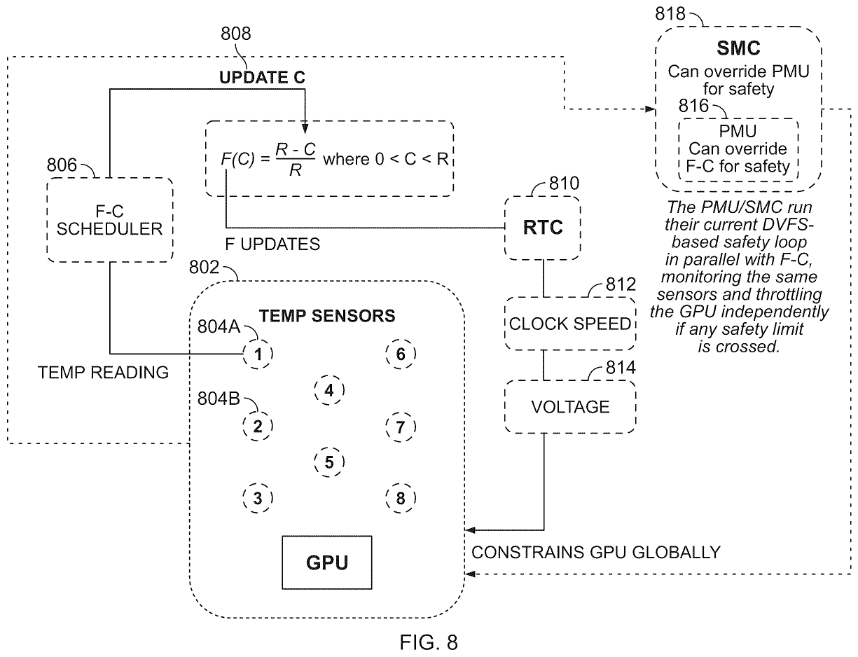

FIG. 8 shows an example automatic calibration system coupled to a graphical processing unit (GPU) according to some embodiments of the invention.

Some embodiments may be used for optimizing resource use within a physical system, such as, e.g., an electrical device or system including one or more second computer processors executing a neural network.

According to some embodiments, an F-C automatic calibration process may run alongside existing PMU and SMC. It may not replace these units, and may provide refined, dynamic, continuous calibration while the PMU and SMC remain in place as safety overrides.

Some embodiments may provide temperature, voltage, and clock-state automatic calibration or adjustments using similar procedures or protocols.

An example GPU system 802 may include one or more elements from FIG. 1 (e.g. processing units coupled to a memory) and may include one or more temperature sensors (e.g., sensor 1 804A, sensor 2 804B, . . . etc.) spread across the die and coupled to and/or in communication with the device or GPU. In some GPU architectures, the PMU and SMC may read telemetry data measured by these sensors, buffer the values, average them, and react only when an averaged value crosses a fixed point in the corresponding DVFS table.

Some embodiments may consider telemetry data corresponding to each sensor reading separately, e.g., one reading at a time. Beginning with sensor No. 1 804A, the F-C scheduler 806 may include one or more elements from FIG. 1 (e.g. processing units coupled to a memory) and may read data values measured by the temperature sensors in a round-robin sequence, convert each temperature reading into R-units using a mapping function, and use that value to update C 808. When C is updated, the equation immediately updates the value of F. The RTC 810 may receive the new value of F and may apply the appropriate temperature adjustment—achieved by raising or lowering the GPU's global clock speed 812 and/or voltage 814 (the two levers that control temperature). Once the RTC applies the appropriate constraint, the F-C scheduler 806 may advances to sensor No. 2 804B, update C based on that reading, and the cycle may repeat itself in a continuous process. Each new sensor reading may update C; the updated C value may immediately produces a new value of F; the RTC may apply the appropriate global constraint; and the scheduler then moves on to the next sensor. This loop may repeat indefinitely, producing continuous, dynamic, real-time calibration. In some embodiments, a PMU 816 may override F-C's adjustments if any PMU-level safety limit is crossed (otherwise, no action may be performed). An SMC 818 may override the PMU if a higher-level thermal or electrical limit is reached (otherwise, no action may be performed).

Voltage and clock speed may be handled by the F-C cycle in a similar manner. For example, voltage may be read from the GPU's existing voltage sensors, and clock speed may be taken directly from the global clock.

Some embodiments may be used for optimizing resource use within a physical system, such as, e.g., a system including a second computer processor, or one or more second computer processors, executing a neural network (where the second computer processor(s) are separate from a first computer processor or processors responsible for executing the F-C process).

As used herein, “second computer processor(s)” may refer to a processor or processors separate and functionally distinct from “first” processors controlling F-C scheduler 806 and a processor incorporated therein, e.g., part of a computer system or physical system controlled by (and, e.g., not controlling) the F-C process. For instance, second computer processor may include a graphical processing unit such as, e.g., GPU system 802—which may itself include multiple CUDA or tensor cores executing neural network operations in parallel, with metrics such as FLOPS utilization, memory bandwidth, and energy per operation monitored by F-C scheduler 806 (which may include a separate, “first” processor). Based on this feedback, the scheduler may dynamically adjust resource allocation, layer placement, or precision (FP32, FP16, sparsity) to optimize system-wide objectives, including latency, throughput, or energy efficiency.

For example, a second computer processor may execute a convolutional neural network (CNN) for image recognition or a transformer model for natural language processing, where task scheduling, batch size, and layer-level parallelism are dynamically adjusted to maintain, e.g., >85% GPU utilization. According to some embodiments, the use of a resource or R within the second processor(s) may describe available computing power, and a constraint C may describe the effect of the thermal state and/or electrical state of the second processor on the available computing power of that processor (see nonlimiting examples provided herein); additional telemetry data and/or system states may be considered in different embodiments.

Some example technological features and improvements that may be offered by some embodiments of the invention are described in Table 21:

### Static Thresholds vs Dynamic Constraints

Conventional DVFS uses static thresholds, so control may be performed in discrete intervals. When temperature, voltage, or clock-state limits are crossed, DVFS makes large, fixed adjustments rather than smooth ones. These abrupt jumps create overshoot, undershoot, and reduced efficiency.

Some embodiments may use dynamic constraints instead of fixed steps. As temperature, voltage, or timing approach their limits, constraints may be applied gradually. This can be done in the RTC using more refined tables or direct math formulas. Because the constraint may change in smaller increments, the RTC may adjust clocks and voltage in smaller increments as well, instead of the large, fixed changes required by DVFS.

### Milliseconds vs Microseconds

Conventional DVFS reacts on the millisecond scale. This millisecond timing is a legacy choice from an earlier GPU era when thermal and power conditions changed more slowly. This slower timing means the GPU waits longer before making a correction, which can cause it to drift further before any adjustment is made. Some embodiments may operate on a microsecond scale. This faster control may allow the system to respond earlier and with smaller corrections, which is a major source of efficiency gain. It may push control timing closer to the physical limits of how quickly clocks and voltage can adjust.

High-Resolution Rules vs. Low-Resolution Rules

Conventional DVFS has a small set of hard-coded static rules. Its tables and thresholds are fixed, so it can change clocks or voltage only in large, predetermined steps—especially compared to the much finer changes possible under F-C. According to some embodiments, RTC (Rule-Trigger-Constraint) may express far higher-resolution control. It may respond in more detailed and nuanced ways:
1. It may use more refined static table entries so changes are smaller and better matched to actual behavior—for example, DVFS might drop 60-100 MHz, while the RTC may make much smaller steps and do so more frequently.
2. It may use various curves instead of hard jumps, so the constraint rises smoothly as conditions approach a limit.
3. It may hold more rules than DVFS, allowing clock and voltage adjustments to be made in smaller, better-timed steps.
4. It may apply higher-resolution rules, enabling finer global adjustments. DVFS would not be able to match this, as it must jump between widely spaced table entries, which leads to overshoot, undershoot, and inefficiency.
   Separate Sensor Values vs. Averaged Values

DVFS may not read each sensor directly. The PMU and SMC briefly buffer and average the temperature and voltage readings, and DVFS responds to this single averaged value. Some embodiments may read each sensor separately. None of the values may be averaged, so the RTC may receive the actual temperature and voltage differences between sensor locations rather than a single blended number, enabling faster and more refined global adjustments. Some embodiments may also trigger the existing local binary controls deliberately. If one region nears a limit, the appropriate RTC may trigger that region's built-in binary control on purpose—not just as an emergency fail-safe—while keeping global adjustment stable.

F-C may be implemented in firmware. It may run as its own loop in parallel with the existing DVFS safety loop. Both loops may read the same sensors. Both loops may use the same built-in clock and voltage controls. However, the PMU/SMC may retains override authority if any safety limit is crossed.

### Table 21

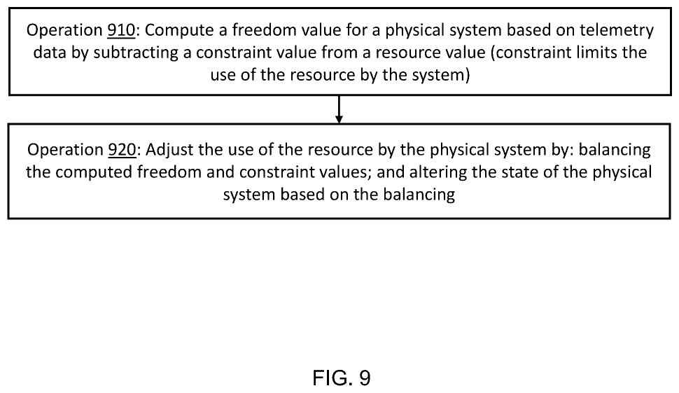

FIG. 9 illustrates an example process for optimizing resource use within a physical system according to some embodiments of the invention.

In operation 910, some embodiments may compute a freedom value for a physical system (such as, e.g., a GPU) based on telemetry data (e.g., compute an F value using the F-C equation or Eq. 1, based on telemetry data such as, e.g., temperature/voltage readings from sensors). Some embodiments may compute of the F value may be performed by subtracting a constraint value from a resource value (see, e.g., Eq. 1), where the resource value describes an amount of a resource provided to the physical system (e.g., power in watts), and wherein the constraint value describes a constraint which limits a use of the resource by the physical system (e.g., the effect of the system's temperature on how much the power supplied to the system may be converted into compute operations). See also nonlimiting example in Table 1.

Some embodiments may then adjust the use of the resource by the physical system (or adjust the utilization of power, or the amount of power used or made available for performing compute operations)—for example by balancing the computed freedom value with respect to the subtracted constraint value, and altering the state of the physical system based on the balancing (for instance, some embodiments may apply constraints to the system to alter its state by increasing or decreasing the system's temperature; this change may be associated with a higher/lower constraint value C that may then be subtracted from resource value R to compute a new, or higher F value. Some embodiments may balance the constraint value C such that the with the resulting F value to prevent inefficiencies or system failure; operation 920). See also nonlimiting example in Table 1. Additional or alternative operations may be performed in different embodiments.

Some nonlimiting use case examples where an F-C process according to some embodiments may be used to adjust the use of resources in the system and/or perform automated actions are provided in Tables 22-23:

### GPU Power Throttling Example

In this nonlimiting example, R is defined as the electrical power delivered from the GPU's voltage regulator. R-units may be defined as an internal control scale used to represent that power for purposes of F-C computation. The GPU considered in this example may be the “second computer processor” being calibrated by some embodiments of the invention (which may use a first computer processor to perform computations, issue control commands, and the like).

A temperature sensor reports 84° C. That measured value may converted by mapping function into an internal R-unit value, and that R-unit value may update C for this cycle (e.g., C=40 R-units).

The mapped value (40 R-units) may update C in the F-C equation: C=40 (reflecting, e.g., a temperature effect or constraint that limits a use of the resource by the GPU-such as for example the amount of electrical power provided to the GPU but being unusable for computation due to the GPU's temperature).

The F-C equation may calculate a new value of F:
F(C)=(R-C)/R, where 0<C<R

Assume R is defined on a 0-100 R-unit scale (as may be established or defined, e.g., by a system designer).

If C=40, then:
F=(100−40)/100=0.60

F=0.60 may indicate that 60% of the defined resource (e.g., electric power provided to the GPU) is currently available for compute work under the current measured condition.

The scheduler makes this F value available to the RTC.

The RTC may compare F=0.60 to a predefined or user defined rule set. For example:
If F≥0.75→maintain clock frequency
If 0.50≤F<0.75→reduce clock by 5%
If F<0.50→reduce clock by 10%

Because F=0.60, the RTC may select the second rule. The RTC may issue a 5% clock reduction command to the actuator.

A state of the GPU may then be altered: for example the state of clock frequency may decrease from 2.0 GHz to 1.90 GHz based on the issued command. Such an adjustment may adjust the use of the resource or electrical power provided to the GPU to perform computations—e.g., by reducing the dynamic-switching power consumed by the GPU's logic units and lowering overall current draw and thermal dissipation requirements during the affected operating interval.

In the next scheduled F-C cycle, the temperature sensor may be read again. The measured value may be mapped into R-units. C may be updated. The F-C equation may be used to compute a new F value. The RTC may apply a corresponding actuator adjustment. The loop may repeat iteratively/continuously.

### Table 22

### Ethereum Node Throughput Regulation Example

In this nonlimiting example, R may be defined as a node's outbound message throughput (messages per second). R-units may be an engineer-defined internal scale used to represent that throughput for purposes of F-C computation.

Assume the system designer defines R on a 0-1000 R-unit scale representing the node's outbound message throughput capacity. The upper bound of the R-unit scale may be engineer-defined and may be adjusted as node capacity or network conditions evolve. Telemetry data reports that the node is currently transmitting at 820 messages per second. On the defined 0-1000 R-unit scale (where 1000 corresponds to 1000 messages per second), 820 messages per second may map directly to 820 R-units.

The mapped value (820 R-units) updates C in the F-C equation: C=820.

The F-C equation calculates a new value of F:
F(C)=(R-C)/R, where 0<C<R
F=(1000−820)/1000=0.18
F=0.18 indicates that 18% of the outbound transmission resource remains available under the current measured condition.

The scheduler makes this F value available to the RTC.

The RTC compares F=0.18 to an engineer-defined rule set. For example:
If F≥0.75→maintain current broadcast rate
If F≥0.50 and F<0.75→reduce outbound message rate by 5%
If F<0.50→reduce outbound message rate by 10%

Because F=0.18, the RTC selects the third rule.

The RTC issues a 10% reduction command to the node's outbound message rate (representing, in this nonlimiting example, the system's state, while the maximal message rate may represent the resource being used).

The node alters or reduces outbound message rate from 820 messages/sec to 738 messages/sec.

In the next scheduled F-C cycle, the message rate is measured again. The measured value is mapped into R-units. C is updated. The F-C equation computes a new F. The RTC applies the corresponding network adjustment. The loop repeats iteratively/continuously.

### Table 23

Additional or alternative use case examples may be considered using different embodiments.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method of optimizing resource use within a physical system, the method comprising, using one or more first computer processors:
based on telemetry data, computing a freedom value for a physical system, wherein the computing is performed by subtracting a constraint value from a resource value, wherein the resource value describes an amount of a resource provided to the physical system, and wherein the constraint value describes a constraint which limits a use of the resource by the physical system; and
adjusting the use of the resource by the physical system, wherein the adjusting comprises: balancing the computed freedom value with respect to the subtracted constraint value, and altering a state of the physical system based on the balancing.

2. The method of claim 1, wherein the physical system comprises an electrical device, wherein the telemetry data comprises data measured by one or more sensors in communication with the electrical device, and wherein the resource comprises electrical power provided to the electrical device.

3. The method of claim 2, wherein the constraint describes one or more of: a thermal state of the electrical device, and an electrical state of the electrical device.

4. The method of claim 2, wherein the sensor readings comprise one or more of: a temperature reading, a voltage reading, and a clock reading.

5. The method of claim 3, wherein the electrical device comprises a second computer processor, the second computer processor separate from the one or more first computer processors, wherein the use of the resource describes available computing power, and wherein the constraint describes the effect of the one or more of: the thermal state of the electrical device, and the electrical state of the electrical device on the available computing power of the second computer processor.

6. The method of claim 5, wherein the second computer processor comprises a graphical processing unit (GPU) and wherein the telemetry data comprises one or more of: a memory bandwidth usage within the GPU, and a network latency across one or more computing nodes.

7. The method of claim 1, wherein the physical system comprises one or more second computer processors executing a neural network.

8. The method of claim 1, comprising iteratively repeating the determining of the constraint, and the adjusting of the use of the resource by the physical system, wherein the adjusting of the use of the resource by the physical system comprises, across one or more iterations, performing one or more of: determining a timing for applying the constraint to the resource, and determining a magnitude for the constraint.

9. The method of claim 2, comprising mapping the data measured by the one or more sensors into an internal control scale, wherein the freedom value is computed using the mapped data.

10. A computerized system for optimizing resource use within a physical system, the computerized system comprising:
a memory; and
one or more first computer processors configured to:
based on telemetry data, compute a freedom value for the physical system, wherein the computing is performed by subtracting a constraint value from a resource value, wherein the resource value describes an amount of a resource provided to the physical system, and wherein the constraint value describes a constraint which limits a use of the resource by the physical system; and
adjust the use of the resource by the physical system, wherein the adjusting comprises: balancing the computed freedom value with respect to the subtracted constraint value, and altering a state of the physical system based on the balancing.

11. The computerized system of claim 10, wherein the physical system comprises an electrical device, wherein the telemetry data comprises data measured by one or more sensors in communication with the electrical device, and wherein the resource comprises electrical power provided to the electrical device.

12. The computerized system of claim 11, wherein the constraint describes one or more of: a thermal state of the electrical device, and an electrical state of the electrical device.

13. The computerized system of claim 11, wherein the sensor readings comprise one or more of: a temperature reading, a voltage reading, and a clock reading.

14. The computerized system of claim 12, wherein the electrical device comprises a second computer processor, the second computer processor separate from the one or more first computer processors, wherein the use of the resource describes available computing power, and wherein the constraint describes the effect of the one or more of: the thermal state of the electrical device, and the electrical state of the electrical device on the available computing power of the second computer processor.

15. The computerized system of claim 14, wherein the second computer processor comprises a graphical processing unit (GPU) and wherein the telemetry data comprises one or more of: a memory bandwidth usage within the GPU, and a network latency across one or more computing nodes.

16. The computerized system of claim 10, wherein the physical system comprises one or more second computer processors executing a neural network.

17. The computerized system of claim 10, wherein the one or more first computer processors are to iteratively repeat the determining of the constraint, and the adjusting of the use of the resource by the physical system, wherein the adjusting of the use of the resource by the physical system comprises, across one or more iterations, performing one or more of: determining a timing for applying the constraint to the resource, and determining a magnitude for the constraint.

18. The computerized system of claim 11, wherein the one or more first computer processors are to map the data measured by the one or more sensors into an internal control scale, wherein the freedom value is computed using the mapped data.

19. A method of calibrating a graphical processing unit (GPU), the method comprising, using one or more first computer processors:
based on telemetry data comprising: a temperature reading, a voltage reading, and a clock reading, calculating a freedom value for the GPU, wherein the GPU comprises one or more second computer processors executing a neural network, the one or more second computer processors separate from the one or more first computer processors,
wherein the computing is performed by subtracting a constraint value from a resource value, wherein the resource value describes an amount of a resource provided to the GPU, and wherein the constraint value describes a constraint which limits a use of the resource by the GPU; and
adjusting the use of the resource by the GPU, wherein the adjusting comprises: balancing the computed freedom value with respect to the subtracted constraint value, and altering a state of the GPU based on the balancing.

20. The method of claim 19, wherein the resource comprises electrical power provided to the GPU, wherein the constraint describes one or more of: a thermal state of the GPU, and an electrical state of the GPU.
